(19) United States
(12) Patent Application Publication
(10) Pub. No.: US 2026/0100737 A1
(43) Pub. Date: Apr. 9, 2026

(54) CSI REPORT WITH CQI VALUES

(71) Applicant: Lenovo (Singapore) Pte. Ltd., Singapore (SG)

(72) Inventors: Ahmed Hindy, Aurora (IL); Vijay Nangia, Woodridge, IL (US)

(21) Appl. No.: 19/113,331

(22) PCT Filed: Sep. 28, 2023
(86) PCT No.: PCT/IB2023/059727

§ 371 Date: Mar. 19, 2025

Related U.S. Application Data
(60) Provisional application No. 63/411,086, filed on Sep. 28, 2022.

(51) Int. Cl. H04B 7/0456; H04L 5/00

(52) U.S. Cl. CPC H04B 7/0481; H04L 5/0057

(57) ABSTRACT

Various aspects of the present disclosure relate to receiving an uplink transmit precoding matrix indicator (TPMI) based on coherence grouping. A user equipment (UE) may be configured to transmit a set of parameters corresponding to an antenna configuration of the UE, where the antenna configuration comprises information on an antenna grouping of the UE, or a coherence grouping across antenna ports of the UE, or both. The UE may be configured to transmit a set of sounding reference signals (SRSs) over the antenna ports based on the antenna configuration. The UE may be configured to receive at least one TPMI based on the set of SRSs, the TPMI corresponding to an uplink (UL) codebook-based transmission.

### TECHNICAL FIELD

The present disclosure relates to wireless communications, and more specifically to uplink (UL) Transmit Precoding Matrix Indication (TPMI) based on coherence grouping.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a UE transmitting a set of parameters corresponding to an antenna configuration of the UE, where the antenna configuration includes information on an antenna grouping of the UE, or a coherence grouping across antenna ports of the UE, or both. The method and apparatuses described herein may further include the UE receiving a codebook configuration associated with an UL codebook-based transmission and transmitting a set of SRSs over the antenna ports based on the antenna configuration. The method and apparatuses described herein may further include the UE receiving at least one TPMI corresponding to the UL codebook-based transmission.

Some implementations of the method and apparatuses described herein may further include a network node (e.g., a base station and/or Radio Access Network (RAN) entity) receiving a set of parameters corresponding to an antenna configuration of a UE, where the antenna configuration includes information on an antenna grouping of the UE, or a coherence grouping across antenna ports of the UE, or both. The method and apparatuses described herein may further include the network node transmitting a codebook configuration associated with an UL codebook-based transmission and receiving a set of SRSs over the antenna ports of the network node based on the antenna configuration. The method and apparatuses described herein may further include the network node transmitting at least one TPMI corresponding to the UL codebook-based transmission.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of codebook indices of i₁ and i₂, in accordance with aspects of the present disclosure.

FIG. 4 illustrates another example of codebook indices of i₁ and i₂, in accordance with aspects of the present disclosure.

FIG. 5 illustrates another example of an Abstract Syntax Notation One (ASN.1) structure of a physical uplink shared channel (PUSCH) Configuration information element (IE), in accordance with aspects of the present disclosure.

FIG. 6 illustrates an example of an ASN.1 structure of a PUSCH Configuration IE, in accordance with aspects of the present disclosure.

FIG. 7 illustrates an example of a user equipment (UE) 700, in accordance with aspects of the present disclosure:

FIG. 8 illustrates an example of a processor 800, in accordance with aspects of the present disclosure.

FIG. 9 illustrates an example of a network equipment (NE) 900, in accordance with aspects of the present disclosure.

FIG. 10 illustrates a flowchart of a method performed by a UE in accordance with aspects of the present disclosure.

FIG. 11 illustrates a flowchart of a method performed by a NE in accordance with aspects of the present disclosure.

### DETAILED DESCRIPTION

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

Generally, the present disclosure describes systems, methods, and apparatuses for UL TPMI based on coherence grouping. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

In 3GPP NR, the resources allocated for feeding back the TPMI for UL transmission is very limited. Two configurations can be supported for signaling the UL precoding matrix. Codebook-based TPMI signaling, in which the network selects a codebook from a set of predefined codebooks for UL transmission, and wherein each codebook is characterized by a transmission rank, an antenna coherence assumption and a specific combination/selection of antenna ports per transmission layer. On the other hand, non-codebook-based transmission is transparent in the sense that the UE transmits a specific group of beamformed SRSs (beams) using one or more SRS resources, and the network selects a subset of the SRS(s) within the group that corresponds to the best beam(s) and indicates them to the UE via an SRS resource indicator (SRI).

In general, the current UL precoding framework uses a very limited number of bits for precoder information at the expense of performance, compared with DL CSI framework in which the CSI fed back from the UE via Uplink Control Information (UCI) can be very large (>1000 bits at large bandwidth), however providing significantly better performance. Aspects of the present disclosure describe a new UL TPMI framework that aims at improving the UL transmission throughput, with reasonable signaling overhead.

One approach to TPMI design is to configure the UE with an UL TPMI that extends the Rel-15 legacy codebook-based TPMI via replicating a same codeword over two antenna groups. However, this approach fits scenarios with partial coherence assumptions, wherein two ports associated with the two antenna groups are non-coherent.

Another approach to TPMI design is to configure the UE with an UL TPMI that is based on a DFT transformation, i.e., based on columns of a DFT matrix. However, this approach fits scenarios with full coherence assumptions, wherein all antenna ports are fully coherent.

Aspects of the present disclosure describe an efficient TPMI design for UL transmission, with the aim of optimizing the tradeoff between the UL codebook performance and the corresponding TPMI signaling overhead. Certain aspects of the present disclosure describe the means of indication of the proposed codebook framework in the specification. Other aspects of the present disclosure describe the precoder structure on which UL codebook is based upon. Finally, additional aspects of the present disclosure describe the means of reporting or signaling/indication of the codebook parameters.

According to a first solution, two parameters are identified corresponding to the antenna configuration at the UE, a first parameter Ng corresponding to the antenna groups of the UE, wherein each antenna group corresponds to a set of antenna ports that are uniformly spaced, e.g., each antenna group corresponds to a panel, and a second parameter Nc corresponding to the coherence groups of the UE, wherein each coherence group corresponds to a set of antenna ports with one of full coherence or partial coherence, whereas two antenna ports belonging to two different coherence groups are non-coherent.

According to a second solution, a codebook type corresponding to TPMI is identified based on at least one of the first parameter Ng corresponding to the antenna groups, the second parameter Nc corresponding to the coherence groups of the UE, the total number of antenna ports at the UE, the total number of vertical antenna ports at the UE and the total number of horizontal antenna ports at the UE.

According to a third solution, two types of partial coherence for antenna ports are defined: a first type of partial coherence wherein up to two ports are associated with a same PUSCH layer transmission, and a second type of partial coherence wherein up to four ports are associated with a same PUSCH layer transmission.

Aspects of the present disclosure are described in the context of a wireless communications system.

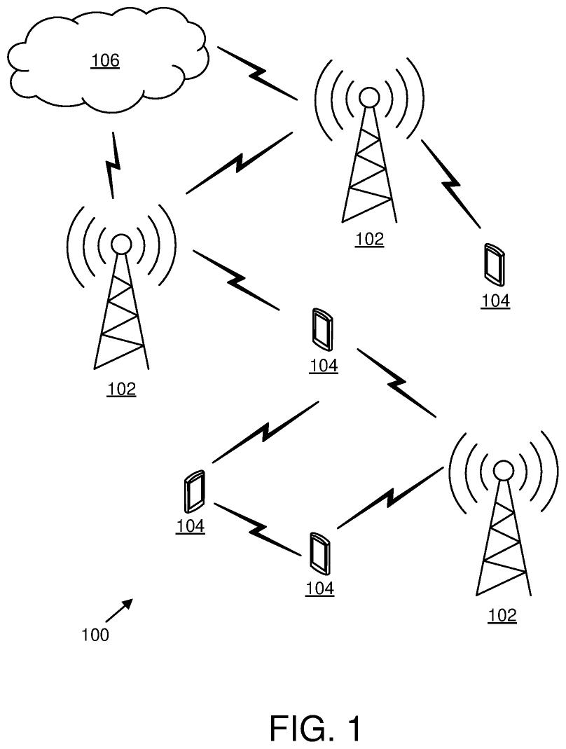

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., Orthogonal Frequency Division Multiplexing symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing: a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

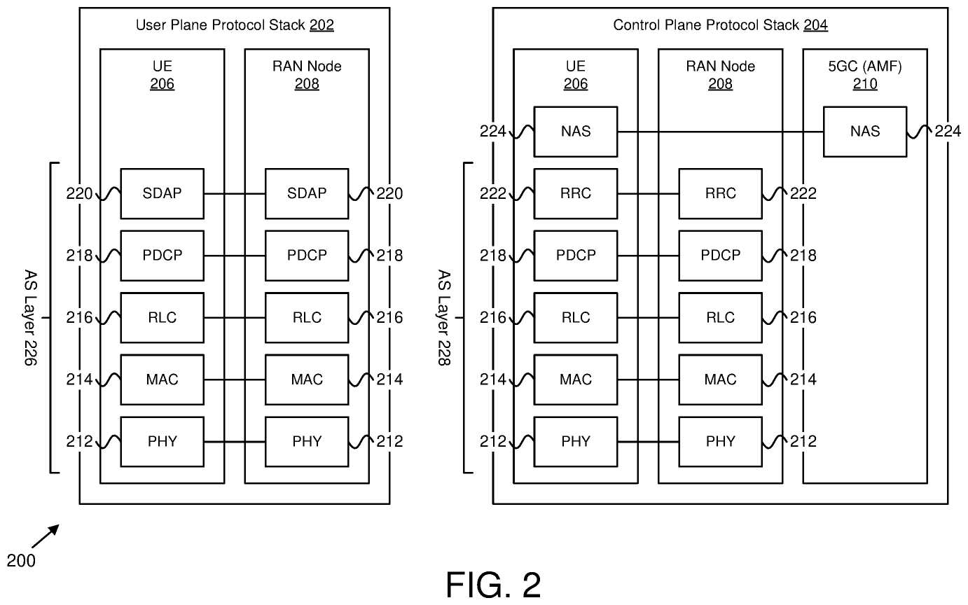

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP layer 220, PDCP sublayer 218, RLC sublayer 216, and MAC sublayer 214. The Layer-3 (L3) includes the RRC layer 222 and the NAS layer 224 for the control plane and includes, e.g., an Internet Protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 240, RRC layer 222 and NAS layer 224) and a transmission layer in Multiple-Input Multiple-Output (MIMO) communication (also referred to as a “MIMO layer” or a “data stream”).

Regarding the 3GPP NR Release 15 (Rel-15) Type-II Codebook, it is assumed that the gNB is equipped with a two-dimensional (2D) antenna array with N1, N2 antenna ports per polarization placed horizontally and vertically and communication occurs over Na PMI subbands. A PMI subband consists of a set of resource blocks, each resource block consisting of a set of subcarriers. In such case, 2N₁N₂ CSI-RS ports are utilized to enable DL channel estimation with high resolution for the NR Rel-15 Type-II codebook. Further details on NR codebook types can be found in 3GPP Technical Specification (TS) 38.214.

In order to reduce the UL feedback overhead, a Discrete Fourier Transform (DFT)-based CSI compression of the spatial domain (SD) is applied to L dimensions per polarization, where L<N₁N₂. In the following, the indices of the 2L dimensions are referred as the SD basis indices. The magnitude and phase values of the linear combination coefficients for each subband are fed back to the gNB as part of the CSI report. The 2N₁N₂×N₃ codebook per transmission layer takes on the form:

$$W = {W}_{1} {W}_{2}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and where the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

$${ν}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T}$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ]$$

$${l}_{i} = {O}_{1} {n}_{1}^{( i )} + {q}_{1} , 0 \leq {n}_{1}^{( i )} < {N}_{1} , 0 \leq {q}_{1} < {O}_{1}$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation. Note that O₁, O₂ oversampling factors are assumed for the 2D DFT matrix from which the matrix B is drawn.

Note that the matrix W₁ is common across all transmission layers. The matrix W₂ is a 2L×N₃ matrix, where the i^{th} column corresponds to the linear combination coefficients of the 2L beams in the i^{th} subband. Only the indices of the L selected columns of B are reported, along with the oversampling index taking on O₁O₂ values. Note that W₂ are independent for different transmission layers.

In more detail, the specification for the NR Rel-15 Type-II Codebook is as follows:

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebook Type set to ‘typeII’

The values of N₁ and N₂ are configured with the higher layer parameter n1-n2-codebookSubsetRestriction. The supported configurations of (N1, N2) for a given number of CSI-RS ports and the corresponding values of (O1, O2) are given in Table 5.2.2.2.1-2 of 3GPP TS 38.214. The number of CSI-RS ports, PCSI-RS, is 2N₁N₂.

The value of L is configured with the higher layer parameter numberOfBeams, where L=2 when PCSI-RS=4 and L∈{2,3,4} when PCSI-RS>4.

The value of N_{PSK} is configured with the higher layer parameter phaseAlphabetSize, where N_{PSK}∈{4,8}.

The UE is configured with the higher layer parameter subbandAmplitude set to ‘true’ or ‘false’. The UE shall not report RI>2.

When v≤2, where v is the associated RI value, each PMI value corresponds to the codebook indices i1 and i2 where

$${i}_{1} = \{ \begin{matrix}[ \begin{matrix}{i}_{1 , 1} & {i}_{1 , 2} & {i}_{1 , 3 , 1} & {i}_{1 , 4 , 1}\end{matrix} ] & υ = 1 \\ [ \begin{matrix}{i}_{1 , 1} & {i}_{1 , 2} & {i}_{1 , 3 , 1} & {i}_{1 , 4 , 1} & {i}_{1 , 3 , 2} & {i}_{1 , 4 , 2}\end{matrix} ] & υ = 2\end{matrix}$$

$${i}_{1} = \{ \begin{matrix}[ {i}_{2 , 1 , 1} ] & subbandAmplitude = ‘ false ’ , υ = 1 \\ [ \begin{matrix}{i}_{2 , 1 , 1} & {i}_{2 , 1 , 2}\end{matrix} ] & subbandAmplitude = ‘ false ’ , υ = 2 \\ [ \begin{matrix}{i}_{2 , 1 , 1} & {i}_{2 , 2 , 1}\end{matrix} ] & subbandAmplitude = ‘ true ’ , υ = 1 \\ [ \begin{matrix}{i}_{2 , 1 , 1} & {i}_{2 , 2 , 1} & {i}_{2 , 1 , 2} & {i}_{2 , 2 , 2}\end{matrix} ] & subbandAmplitude = ‘ true ’ , υ = 2\end{matrix} .$$

The L vectors combined by the codebook are identified by the indices i1.1 and i1.2, where

$${i}_{1 , 1} = [ \begin{matrix}{q}_{1} & {q}_{2}\end{matrix} ]$$

$${q}_{1} ∈ \{ 0 , 1 , … , {O}_{1} - 1 \}$$

$${q}_{2} ∈ \{ 0 , 1 , … , {O}_{2} - 1 \}$$

$${i}_{1 , 2} ∈ \{ 0 , 1 , … , ( \begin{matrix}{N}_{1} {N}_{2} \\ L\end{matrix} ) - 1 \} .$$

$$Let$$

$${n}_{1} = [ {n}_{1}^{( 0 )} , … , {n}_{1}^{( L - 1 )} ]$$

$${n}_{2} = [ {n}_{2}^{( 0 )} , … , {n}_{2}^{( L - 1 )} ]$$

$${n}_{1}^{( i )} ∈ \{ 0 , 1 , … , {N}_{2} - 1 \}$$

$${n}_{2}^{( i )} ∈ \{ 0 , 1 , … , {N}_{2} - 1 \}$$

$$and$$

$$C ( x , y ) = \{ \begin{matrix}( \begin{matrix}x \\ y\end{matrix} ) & x \geq y \\ 0 & x < y\end{matrix} .$$

where the values of C(x, y) are given in Table 1 (taken from Table 5.2.2.2.3-1 of 3GPP TS 38.214).

Then the elements of n1 and n2 are found from i1,2 using the algorithm:

$${s}_{- 1} = 0$$

$$for i - 0 , … , L - 1$$

Find the largest x*∈{L−1−i, . . . , N₁N₂−1−i} in Table 1 such that

$$i 1 , 2 - si - 1 \geq C ( {x}^{*} , L - i )$$

$${e}_{i} = C ( {x}^{*} , L - i )$$

$${s}_{i} = {s}_{i - 1} + {e}_{i}$$

$${n}^{( i )} = {N}_{1} {N}_{2} - 1 - {x}^{*}$$

$${n}_{1}^{( i )} = {n}^{( i )} mod {N}_{1}$$

$${n}_{2}^{( i )} = \frac{( {n}^{( i )} - {n}_{1}^{( i )} )}{{N}_{1}}$$

When m₁ and n2 are known, i_{1,2} is found using:

$${n}^{( i )} = {N}_{1} {n}_{2}^{( i )} + {n}_{1}^{( i )}$$

where the indices i=0, 1, . . . , L−1 are assigned such that n(i) increases as i increases

$${i}_{1 , 2} = {\sum }_{i = 0}^{L - 1} C ( {N}_{1} {N}_{2} - 1 - {n}^{( i )} , L - i ) ,$$

where C(x, y) is given in Table 1.

If N2=1, q2=0 and n2(i)=0 for i=0, 1, . . . , L−1, and q2 is not reported. When (N1, N2)=(2,1), n1=[0,1] and n2=[0,0], and i1,2 is not reported. When (N1, N2)=(4,1) and L=4, n1=[0, 1, 2, 3] and n2=[0, 0, 0, 0], and i1,2 is not reported. When (N1, N2)=(2,2) and L=4, n1=[0, 1, 0, 1] and n2=[0, 0, 1, 1], and i1,2 is not reported.

TABLE 1
Combinatorial coefficients C(x, y)

y

| x | 1 | 2 | 3 | 4 |
|---|---|---|---|---|
| 0 | 0 | 0 | 0 | 0 |
| 1 | 1 | 0 | 0 | 0 |
| 2 | 2 | 1 | 0 | 0 |
| 3 | 3 | 3 | 1 | 0 |
| 4 | 4 | 6 | 4 | 1 |
| 5 | 5 | 10 | 10 | 5 |
| 6 | 6 | 15 | 20 | 15 |
| 7 | 7 | 21 | 35 | 35 |
| 8 | 8 | 28 | 56 | 70 |
| 9 | 9 | 36 | 84 | 126 |
| 10 | 10 | 45 | 120 | 210 |
| 11 | 11 | 55 | 165 | 330 |
| 12 | 12 | 66 | 220 | 495 |
| 13 | 13 | 78 | 286 | 715 |
| 14 | 14 | 91 | 364 | 1001 |
| 15 | 15 | 105 | 455 | 1365 |

The strongest coefficient on layer l=1 . . . v is identified by i_{1,3,l} ∈{0, 1 . . . 2L−1}.

The amplitude coefficient indicators i_{1,4,l} and i_{2,2,l} are

$${i}_{1 , 4 , l} = [ {k}_{l , 0}^{( 1 )} , {k}_{l , 1}^{( 1 )} , … , {k}_{l , 2 L - 1}^{( 1 )} ]$$

$${i}_{2 , 2 , l} = [ {k}_{l , 0}^{( 2 )} , {k}_{l , 1}^{( 2 )} , … , {k}_{l , 2 L - 1}^{( 2 )} ]$$

$${k}_{l , i}^{( 1 )} ∈ \{ 0 , 1 , … , 7 \}$$

$${k}_{l . i}^{( 2 )} ∈ \{ 0 , 1 \}$$

for l=1, . . . , v. The mapping from

$${k}_{l , i}^{( 1 )}$$

to the amplitude coefficient

$${P}_{l , i}^{( 1 )}$$

is given in Table 2 (taken from Table 5.2.2.2.3-2 of 3GPP TS 38.214) and the mapping from

$${k}_{l , i}^{( 2 )}$$

to the amplitude coefficient

$${p}_{l , i}^{( 2 )}$$

is given in Table 3 (taken from fable 5.2.2.2.3-3 of 3GPP TS 38.214). The amplitude coefficients are represented by

$${p}_{l}^{( 1 )} = [ {p}_{l , 0}^{( 1 )} , {p}_{l , i}^{( 1 )} , … , {p}_{l , 2 L - 1}^{( 1 )} ]$$

$${p}_{l}^{( 2 )} = [ {p}_{l , 0}^{( 2 )} , {p}_{l , i}^{( 2 )} , … , {p}_{l , 2 L - 1}^{( 2 )} ]$$

for l=1, . . . , v.

TABLE 2
Mapping of elements of
${i}_{1 , 4 , l} : {k}_{l , i}^{( 1 )} to {p}_{l , i}^{( 1 )}$

| ${k}_{l , i}^{( 1 )}$ | ${p}_{l , i}^{( 1 )}$ |
|---|---|
| 0 | 0 |
| 1 | \sqrt{1/64} |
| 2 | \sqrt{1/32} |
| 3 | \sqrt{1/16} |
| 4 | \sqrt{1/8} |
| 5 | \sqrt{1/4} |
| 6 | \sqrt{1/2} |
| 7 | 1 |

TABLE 3
Mapping of elements of
${i}_{2 , 2 , l} : {k}_{l , i}^{( 2 )} to {p}_{l , i}^{( 2 )}$

| ${k}_{l , i}^{( 2 )}$ | ${p}_{l , i}^{( 2 )}$ |
|---|---|
| 0 | \sqrt{1/2} |
| 1 | 1 |

The phase coefficient indicators are

$${i}_{2 , 1 , l} = [ {c}_{l , 0} , {c}_{l , 1} , … , {c}_{l , 2 L - 1} ]$$

for l=1, . . . , v.

The amplitude and phase coefficient indicators are reported as follows the indicators

$${k}_{l , {i}_{1 , 3 , l}}^{( 1 )} = 7 , {k}_{l , {i}_{1 , 3 , l}}^{( 2 )} = 1 , and {c}_{l , {i}_{1 , 3 , l}} = 0 ( l = 1 , … , v ) .$$

$${k}_{l , {i}_{1 , 3 , l}}^{( 1 )} , {k}_{l , {i}_{1 , 3 , l}}^{( 2 )} , and {c}_{l , {i}_{1 , 3 , l}}$$

are not reported for l=1, . . . , v. The remaining 2L−1 elements of i_{1,4,l} (l=1, . . . , v) are reported, where

$${k}_{l , i}^{( 1 )}$$

∈{0, 1, . . . , 7}. Let Mₗ(l=1, . . . , v) be the number of elements of i_{1,4,l} that satisfy

$${k}_{l , i}^{( 1 )} > 0 .$$

The remaining 2L−1 elements of i_{2,1,l} and i_{2,2,l} (l=1, . . . , v) are reported as follows:

When subbandAmplitude is set to ‘false’, to ‘false’,

$${k}_{l , i}^{( 2 )} = 1$$

for l=1, . . . , v, and i=0, 1, . . . , 2L−1. i_{2,2,l} is not reported for l=1, . . . , v. For l=1, . . . , v, the elements of i_{2,2,l} corresponding to the coefficients that satisfy

$${k}_{l , i}^{( 1 )} > 0 ,$$

i≠i_{1,3,l} as determined by the reported elements of i_{1,4,l} are reported, c_{l,i}∈{0, 1, . . . , N_{PSK}−1} and the remaining 2L-Mₗ elements of i_{2,2,l} are not reported and are set to c_{l,i}=0.

When subbandAmplitude is set to ‘true’, for l=1, . . . , v, the elements of i_{2,2,l} and i_{2,1,l} corresponding to the min (Mₗ, K⁽²⁾)−1 strongest coefficients (excluding the strongest coefficient indicated by i_{1,3,l}), as determined by the corresponding reported elements of i_{1,4,l}, are reported, where

$${k}_{l , i}^{( 2 )}$$

∈{0,1} and c_{l,i}∈{0, 1, . . . , N_{PSK}−1}.

The values of K⁽²⁾ are given in Table 4 (taken from Table 5.2.2.2.3-4 of 3GPP TS 38.214). The remaining 2L-min (Mₗ, K⁽²⁾) elements of i_{2,2,l} are not reported and are set to

$${k}_{l , i}^{( 2 )} = 1.$$

The elements of i_{2,2,l} corresponding to the Mₗ-min (Mₗ, K⁽²⁾) weakest non-zero coefficients are reported, where c_{l,i}∈{0, 1, 2, 3}. The remaining 2L-Mₗ elements of i_{2,2,l} are not reported and are set to c_{l,i}=0.

When two elements,

$${k}_{l , x}^{( 1 )} and {k}_{l , y}^{( 1 )} ,$$

of the reported elements of i_{1,4,l} are identical

$$( {k}_{l , x}^{( 1 )} = {k}_{l , y}^{( 1 )} ) ,$$

then element min(x,y) is prioritized to be included in the set of the min (Mₗ, K⁽²⁾)−1 strongest coefficients for i_{2,2,l} and i_{2,2,l} (l=1, . . . , v) reporting.

TABLE 4
Full resolution subband coefficients
when subbandAmplitude is set to ‘true’

| L | K⁽²⁾ |
|---|---|
| 2 | 4 |
| 3 | 4 |
| 4 | 6 |

The codebooks for 1 or 2 layers are given in Table 5 (taken from Table 5.2.2.2.3-5 of 3GPP TS 38.214), where the indices m₁⁽ⁱ⁾ and m₂⁽ⁱ⁾ are given by

$${m}_{1}^{( i )} = {O}_{1} {n}_{1}^{( i )} + {q}_{1}$$

$${m}_{2}^{( i )} = {O}_{2} {n}_{2}^{( i )} + {q}_{2}$$

For i=0, 1, . . . , L−1, and the quantities φ_{l,i}, uₘ, and v_{l,m} are given by

$${φ}_{l , i} = \{ \begin{matrix}{e}^{j 2 π {c}_{l , i} / {N}_{PSK}} & subbandAmplitude = ' false ' \\ {e}^{j 2 π {c}_{l , i} / {N}_{PSK}} & \begin{matrix}subbandAmplitude = ' true ' , min ( {M}_{l} , {K}^{( 2 )} ) \\ strongest coefficients ( including {i}_{1 , 3 , l} ) with {k}_{l , i}^{( 1 )} > 0\end{matrix} \\ {e}^{j 2 π {c}_{l , i} / 4} & \begin{matrix}subbandAmplitude = ' true ' , {M}_{l} - min ( {M}_{l} , {K}^{( 2 )} ) \\ weakest coefficients with {k}_{l , i}^{( 1 )} > 0\end{matrix} \\ 1 & \begin{matrix}subbandAmplitude = ' true ' , \\ 2 L - {M}_{l} coefficients with {k}_{l , i}^{( 1 )} = 0\end{matrix}\end{matrix}$$

$${u}_{m} = \{ \begin{matrix}[ \begin{matrix}\begin{matrix}\begin{matrix}1 & {e}^{j \frac{2 π m}{{O}_{2} {N}_{2}}}\end{matrix} & …\end{matrix} & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

TABLE 5
Codebook for 1-layer and 2-layer CSI reporting using antenna ports 3000 to
2999 + PCSI-RS

| Layers | |
|---|---|
| υ = 1 | ${W}_{{q}_{1} , {q}_{2} , {n}_{1} , {n}_{2} , {p}_{1}^{( 1 )} , {p}_{1}^{( 2 )} , {i}_{2 , 1 , 1}}^{( 1 )} = {W}_{{q}_{1} , {q}_{2} , {n}_{1} , {n}_{2} , {p}_{1}^{( 1 )} , {p}_{1}^{( 2 )} , {i}_{2 , 1 , 1}}^{1}$ |
| υ = 2 | ${W}_{{q}_{1} , {q}_{2} , {n}_{1} , {n}_{2} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ \begin{matrix}{W}_{{q}_{1} , {q}_{2} , {n}_{1} , {n}_{2} , {p}_{1}^{( 1 )} , {p}_{1}^{( 2 )} , {i}_{2 , 1 , 1}}^{1} & {W}_{{q}_{1} , {q}_{2} , {n}_{1} , {n}_{2} , {p}_{2}^{( 1 )} , {p}_{2}^{( 2 )} , {i}_{2 , 1 , 2}}^{2}\end{matrix} ]$ |

$where {W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} {m}_{2}^{( i )}} {p}_{l , i}^{( 1 )} {p}_{l , i}^{( 2 )} {φ}_{l , i} \\ {\sum }_{i = 0}^{L - 1} {v}_{{m}^{( i )} {m}_{2}^{( i )}} {p}_{l , i + L}^{( 1 )} {p}_{l , i + L}^{( 2 )} {φ}_{l , i + L}\end{matrix} ] , l = 1 , 2 ,$
and the mappings from i₁ to q₁, q₂, n₁, n₂, p₁⁽¹⁾, and p₂⁽¹⁾, and from i₂ to i_{2,1,1}, i_{2,1,2}, p₁⁽²⁾ and p₂⁽²⁾ are as
described above, including the ranges of the constituent indices of i₁ and i₂.

When the UE is configured with higher layer parameter codebook Type set to ‘typeII’, the bitmap parameter typeII-RI-Restriction forms the bit sequence r₁, r₀ where r₀ is the LSB and r₁ is the MSB. When r₁ is zero, i∈{0,1}, PMI and RI reporting are not allowed to correspond to any precoder associated with v=i+1 layers. The bitmap parameter n1-n2-codebookSubsetRestriction forms the bit sequence B=B₁B₂ where bit sequences B₁, and B₂ are concatenated to form B. To define B₁ and B₂, first define the O₁O₂ vector groups G (r₁, r₂) as

$$G ( {r}_{1} , {r}_{2} ) = \{ {v}_{{N}_{1} {r}_{1} + {x}_{1} , {N}_{2} {r}_{2} + {x}_{2}} : {x}_{1} = 0 , 1 , … , {N}_{1} - 1 ; {x}_{2} = 0 , 1 , … , {N}_{2} - 1 \}$$

$$for$$

$${r}_{1} ∈ \{ 0 , 1 , … , {O}_{1} - 1 \}$$

$${r}_{2} ∈ \{ 0 , 1 , … , {O}_{2} - 1 \} .$$

The UE shall be configured with restrictions for 4 vector groups indicated by (r₁^{(k)}, r₂^{(k)}) for k=0, 1, 2, 3 and identified by the group indices

$${g}^{( k )} = {O}_{1} {r}_{2}^{( k )} + {r}_{1}^{( k )}$$

For k=0, 1, . . . , 3, where the indices are assigned such that g(k) increases as k increases. The remaining vector groups are not restricted.

If N₂=1, g^{(k)}=k for k=0, 1, . . . , 3, and B₁ is empty.

### If N₂>1.

$${B}_{1} = {b}_{1}^{( 10 )} … {b}_{1}^{( 0 )}$$

is the binary representation of the integer β₁ where

$${b}_{1}^{( 10 )}$$

### is the MSB and

$${b}_{1}^{( 0 )}$$

is the LSB. β₁ is found using:

$${β}_{1} = {\sum }_{k = 0}^{3} C ( {O}_{1} {O}_{2} - 1 - {g}^{( k )} , 4 - k ) ,$$

where C(x, y) is defined in Table 1. The group indices g(k) and indicators

$$( {r}_{1}^{( k )} , {r}_{2}^{( k )} )$$

for k=0, 1, 2, 3 may be found from β₁ using the algorithm:

$${s}_{- 1} = 0$$

for k=0, . . . , 3

Find the largest x*∈{3−k, . . . , O₁O₂−1−k} such that β₁−sₖ₋₁≥C(x*, 4−k)

$${e}_{k} = C ( x * , 4 - k )$$

$${s}_{k} = {s}_{k - 1} + {e}_{k}$$

$${g}^{( k )} = {O}_{1} {O}_{2} - 1 - x *$$

$${r}_{1}^{( k )} = {g}^{( k )} mod {O}_{1}$$

$${r}_{2}^{( k )} = \frac{( {g}^{( k )} - {r}_{1}^{( k )} )}{{O}_{1}}$$

The bit sequence

$${B}_{2} = {B}_{2}^{( 0 )} {B}_{2}^{( 1 )} {B}_{2}^{( 2 )} {B}_{2}^{( 3 )}$$

is the concatenation of the bit sequences

$${B}_{2}^{( k )}$$

for k=0, 1, . . . , 3, corresponding to the group indices g^{(k)}. The bit sequence

$${B}_{2}^{( k )}$$

is defined as

$${B}_{2}^{( k )} = {b}_{2}^{( k , 2 {N}_{1} {N}_{2} - 1 )} … {b}_{2}^{( k , 0 )}$$

Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed amplitude coefficient

$${p}_{l , i}^{( 1 )}$$

for the vector in group g^{(k)} indexed by x₁, x₂, where the maximum amplitude coefficients are given in Table 6 (taken from Table 5.2.2.2.3-6 of 3GPP TS 38.214). A UE that does not report parameter amplitudeSubsetRestriction=‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01$$

or 10.

TABLE 6
Maximum allowed amplitude coefficients for restricted vectors

| | Maximum Amplitude Coefficient |
|---|---|
| $Bits {b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | ${p}_{l , i}^{( 1 )}$ |
| 00 | 0 |
| 01 | \sqrt{1/4} |
| 10 | \sqrt{1/2} |
| 11 | 1 |

Regarding 3GPP NR Rel-15, for Type-II Port Selection (PS) codebook, only K (where K≤2N₁N₂) beamformed CSI-RS ports are utilized in DL transmission, in order to reduce complexity. The K×N₃ codebook matrix per transmission layer takes on the form:

$$W = {W}_{1}^{PS} {W}_{2}$$

Here, the matrices W₂ follow the same structure as the conventional NR Rel-15 Type-II Codebook (e.g., described above) and are transmission layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is a

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1, 2, 3, 4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. The matrix W₁ is common across all transmission layers.

For K=16, L=4 and d_{PS}=1, the 8 possible realizations of E corresponding to m_{PS}={0, 1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] ,$$

When d_{PS}=2, the 4 possible realizations of E corresponding to m_{PS}={0, 1, 2, 3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0, 1, 2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of m_{PS}={0,1} are as

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In more detail, the specification for the NR Rel-15 Type-II Port Selection Codebook is as follows:
For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection’

The number of CSI-RS ports is given by P_{CSI-RS}∈{4, 8, 12, 16, 24, 32} as configured by higher layer parameter nrofPorts.

The value of L is configured with the higher layer parameter numberOfBeams, where L=2 when P_{CSI-RS}=4 and L∈{2,3,4} when P_{CSI-RS}>4.

The value of d is configured with the higher layer parameter portSelectionSamplingSize, where d∈{1, 2, 3, 4} and d≤min

$$( \frac{{P}_{CSI - RS}}{2} , L ) .$$

The value of N_{PSK} is configured with the higher layer parameter phase AlphabetSize, where N_{PSK}∈{4,8}.

The UE is configured with the higher layer parameter subbandAmplitude set to ‘true’ or ‘false’.

The UE shall not report RI>2.

The UE is also configured with the higher layer parameter typeII-PortSelectionRI-Restriction. The bitmap parameter typeII-PortSelectionRI-Restriction forms the bit sequence r₁,r₀ where, is the LSB and r₁ is the MSB. When r₁ is zero, i∈{0,1}, PMI and RI reporting are not allowed to correspond to any precoder associated with v=i+1 layers.

When v≤2, where v is the associated RI value, each PMI value corresponds to the codebook indices i1 and i2 where

$${i}_{1} = \{ \begin{matrix}[ \begin{matrix}{i}_{1 , 1} & {i}_{1 , 3 , 1} & {i}_{1 , 4 , 1}\end{matrix} ] & υ = 1 \\ [ \begin{matrix}{i}_{1 , 1} & {i}_{1 , 3 , 1} & {i}_{1 , 4 , 1} & {i}_{1 , 3 , 2} & {i}_{1 , 4 , 2}\end{matrix} ] & υ = 2\end{matrix}$$

$${i}_{2} = \{ \begin{matrix}[ {i}_{2 , 1 , 1} ] & subbandAmplitude = ‘ false ’ , υ = 1 \\ [ \begin{matrix}{i}_{2 , 1 , 1} & {i}_{2 , 1 , 2}\end{matrix} ] & subbandAmplitude = ‘ false ’ , υ = 2 \\ [ \begin{matrix}{i}_{2 , 1 , 1} & {i}_{2 , 2 , 1}\end{matrix} ] & subbandAmplitude = ‘ true ’ , υ = 1 \\ [ \begin{matrix}{i}_{2 , 1 , 1} & {i}_{2 , 2 , 1} & {i}_{2 , 1 , 2} & {i}_{2 , 2 , 2}\end{matrix} ] & subbandAmplitude = ‘ true ’ , υ = 2\end{matrix}$$

The L antenna ports per polarization are selected by the index i1,1, where

$${i}_{1 , 1} ∈ \{ 0 , 1 , … , ⌈ \frac{{P}_{CSI - RS}}{2 d} ⌉ - 1 \}$$

The strongest coefficient on layer l, l=1, . . . , v is identified by i_{1,3,l}∈{0, 1, . . . , 2L−1}.

The amplitude coefficient indicators i_{1,4,l} and i_{2,2,l} are

$${i}_{1 , 4 , l} = [ {k}_{l , 0}^{( 1 )} , {k}_{l , 1}^{( 1 )} , … , {k}_{l , 2 L - 1}^{( 1 )} ]$$

$${i}_{2 , 2 , l} = [ {k}_{l , 0}^{( 2 )} , {k}_{l , 1}^{( 2 )} , … , {k}_{l , 2 L - 1}^{( 2 )} ]$$

$${k}_{l , i}^{( 1 )} ∈ \{ 0 , 1 , … , 7 \}$$

$${k}_{l , i}^{( 2 )} ∈ \{ 0 , 1 \}$$

for l=1, . . . , v. The mapping from

$${k}_{l , i}^{( 1 )}$$

to the amplitude coefficient

$${p}_{l , i}^{( 1 )}$$

is given in Table 2 and the mapping from

$${k}_{l , i}^{( 2 )}$$

to the amplitude coefficient

$${p}_{l , i}^{( 2 )}$$

is given in Table 3. The amplitude coefficients are represented by

$${p}_{l}^{( 1 )} = [ {p}_{l , 0}^{( 1 )} , {p}_{l , 1}^{( 1 )} , … , {p}_{l , 2 L - 1}^{( 1 )} ]$$

$${p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . , v.

The phase coefficient indicators are

$${i}_{2 , 1 , l} = [ {c}_{l , 0} , {c}_{l , 1} , … , {c}_{l , 2 L - 1} ]$$

for l=1, . . . , v.

The amplitude and phase coefficient indicators are reported as follows:

The indicators

$${k}_{l , {i}_{1 , 3 , l}}^{( 1 )} = 7 , {k}_{l , {i}_{1 , 3 , l}}^{( 2 )} = 1 , and {c}_{l , {i}_{1 , 3 , l}} = 0 ( l - 1 , … , υ ) \cdot {k}_{l , {i}_{1 , 3 , l}}^{( 1 )} , {k}_{l , {i}_{1 , 3 , l}}^{( 2 )} ,$$

and c_{l,i}_{_{1,3,l}} are not reported for l=1, . . . , v.

The remaining 2L−1 elements of i_{1,4,l}(l=1, . . . , v) are reported, where

$${k}_{l , i}^{( 1 )}$$

∈{0, 1, . . . , 7}. Let Mₗ(l=1, . . . , v) be the number of elements of i_{1,4,l} that satisfy

$${k}_{l , i}^{( 1 )} > 0 .$$

The remaining 2L−1 elements of i_{2,1,l} and i_{2,2,l} (l=1, . . . , v) are reported as follows:

When subbandAmplitude is set to ‘false’,

$${k}_{l , i}^{( 2 )} = 1$$

for l=1, . . . , υ, and i=0, 1, . . . , 2L−1. i_{2,2,l} is not reported for l=1, . . . , v. For l=1, . . . , v, the Mₗ−1 elements of i_{2,1,l} corresponding to the coefficients that satisfy

$${k}_{l , i}^{( 1 )} > 0 ,$$

i≠i_{1,3,l}, as determined by the reported elements of i_{1,4,l}, are reported, where c_{l,i}∈{0, 1, . . . , N_{PSK}−1} and the remaining 2L−Mₗ elements of i2, 1/are not reported and are set to c_{l,i}=0.

When subbandAmplitude is set to ‘true’, for l=1, . . . , v, the elements of i_{2,2,l} and i_{2,2,l} corresponding to the min (Mₗ, K⁽²⁾)−1 strongest coefficients (excluding the strongest coefficient indicated by i_{1,3,l}), as determined by the corresponding reported elements of i_{1,4,l}, are reported, where

$${k}_{l , i}^{( 2 )}$$

∈{0,1} and c_{l,i}∈{0, 1, . . . , N_{PSK}−1}. The values of K⁽²⁾ are given in Table 4.

The remaining 2L-min (Mₗ, K⁽²⁾) elements of i_{2,2,l} are not reported and are set to

$${k}_{l , i}^{( 2 )} = 1.$$

The elements of i_{2,1,l} corresponding to the Mₗ-min (Mₗ, K⁽²⁾ weakest non-zero coefficients are reported, where c_{i,l}∈{0, 1, 2, 3}. The remaining 2L-Mi elements of i_{2,1,l} are not reported and are set to c_{i,l}=0.

When two elements,

$${k}_{l , x}^{( 1 )} and {k}_{l , y}^{( 1 )} ,$$

of the reported elements of i_{1,4,l} are identical

$$( {k}_{l , x}^{( 1 )} = {k}_{l , y}^{( 1 )} ) ,$$

then element min (x,y) is prioritized to be included in the set of the min (Mₗ, K⁽²⁾)−1 strongest coefficients for i_{2,1,l} and i_{2,2,l} (l=1, . . . , v) reporting.

The codebooks for 1-2 layers are given in Table 7 (taken from Table 5.2.2.2.4-1 of 3GPP TS 38.214), where the quantity (1 is given by

$${φ}_{l , i} = \{ \begin{matrix}{e}^{j 2 π {c}_{l , i} / {N}_{PSK}} & subbandAmplitude = {}^{‵} {false}^{′} \\ {e}^{j 2 π {c}_{l , i} / {N}_{PSK}} & subbandAmplitude = {}^{‵} {true}^{′} min ( {M}_{l} , {K}^{( 2 )} ) strongest coefficients ( including {i}_{1 , 3 , l} ) with {k}_{l , i}^{( 1 )} > 0 \\ {e}^{j 2 π {c}_{l , i} / 4} & subbandAmplitude = {}^{‵} {true}^{′} , {M}_{l} - min ( {M}_{l} , {K}^{( 2 )} ) weakest coefficients with {k}_{l , i}^{( 1 )} > 0 \\ 1 & subbandAmplitude = {}^{‵} {true}^{′} , 2 L - {M}_{l} coefficients with = {k}_{l , i}^{( 1 )} = 0\end{matrix}$$

and vₘ is a P_{CSI-RS}/2-element column vector containing a value of 1 in element (m mod P_{CSI-RS}/2) and zeros elsewhere (where the first element is element 0).

TABLE 7
Codebook for 1-layer and 2-layer CSI reporting using antenna ports 3000 to 2999 + P_{CSI-RS}

| Layers | |
|---|---|
| υ = 1 | ${W}_{{i}_{1 , 1} , {p}_{1}^{( 1 )} , {p}_{1}^{( 2 )} , {i}_{2 , 1 , 1}}^{( 1 )} = {W}_{{i}_{1 , 1} , {p}_{1}^{( 1 )} , {p}_{1}^{( 2 )} , {i}_{2 , 1 , 1}}^{1}$ |
| υ = 2 | ${W}_{{i}_{1 , 1} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ \begin{matrix}{W}_{{i}_{1 , 1} , {p}_{1}^{( 1 )} , {p}_{1}^{( 2 )} , {i}_{2 , 1 , 1}}^{1} & {W}_{{i}_{1 , 1} , {p}_{2}^{( 1 )} , {p}_{2}^{( 2 )} , {i}_{2 , 1 , 2}}^{2}\end{matrix}$ |

$where {W}_{{i}_{1 , 1} , {p}_{l}^{( 1 )} , {p}_{l}^{( 2 )} , {i}_{2 , 1 , l}}^{l} = \frac{1}{\sqrt{{\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{i}_{1 , 1} d + i} {p}_{l , i}^{( 1 )} {p}_{l , i}^{( 2 )} {φ}_{l , i} \\ {\sum }_{i = 0}^{L - 1} {v}_{{i}_{1 , 1} d + i} {p}_{l , i + L}^{( 1 )} {p}_{l , i + L}^{( 2 )} {φ}_{l , i + L}\end{matrix} ] , l = 1 , 2 ,$
and the mappings from i₁ to i_{1,1}, p₁⁽¹⁾, and p₂⁽¹⁾ and from i₂ to i_{2,1,1}, i_{2,1,2}, p₁⁽²⁾, and p₂⁽²⁾ are as described
above, including the ranges of the constituent indices of i₁ and i₂.

Regarding 3GPP NR Rel-15, the Type-I codebook is the baseline codebook for NR, with a variety of configurations. The most common utility of Rel-15 Type-I codebook is a special case of NR Rel-15 Type-II codebook with L=1 for Rank Indicator (RI)=1, 2, wherein a phase coupling value is reported for each subband, i.e., W_{2,l} is 2×N₃, with the first row equal to [1, 1, . . . , 1] and the second row equal to [e^{j2πØ}^{₀}, . . . , e^{j2πØ}^{₃₋₁}]. Under specific configurations, φ₀=φ₁ . . . =φ, i.e., wideband reporting. For RI>2, different beams are used for each pair of transmission layers. The NR Rel-15 Type-I codebook may be depicted as a low-resolution version of NR Rel-15 Type-II codebook with spatial beam selection per transmission-layer-pair and phase combining only.

Regarding the 3GPP NR Rel-16 Type-II Codebook, it is assumed that the gNB is equipped with a 2D antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel-16 Type-II codebook. In order to reduce the UL feedback overhead, a DFT-based CSI compression of the SD is applied to L dimensions per polarization, where L<N₁N₂. Similarly, additional compression in the Frequency Domain (FD) is applied, where each beam of the FD precoding vectors is transformed using an inverse DFT matrix to the delay domain, and the magnitude and phase values of a subset of the delay-domain coefficients are selected and fed back to the gNB as part of the CSI report.

The 2N₁N₂×N₃ codebook per transmission layer takes on the form:

$$W = {W}_{1} {\tilde{W}}_{2 , l} {W}_{f}^{H}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}1 & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ]$$

$${l}_{i} = {O}_{1} {n}_{1}^{( i )} + {q}_{1} , 0 \leq {n}_{1}^{( i )} < {N}_{1} , 0 \leq {q}_{1} {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} {O}_{2} ,$$

where the superscript ^{T} denotes a matrix transposition operation, and the superscript ^{H} denotes a matrix Hermitian, i.e., conjugate transposition operator. Note that O₁, O₂ oversampling factors are assumed for the 2D DFT matrix from which matrix B is drawn. Note that W₁ is common across all transmission layers. In various embodiments, the above parameters comply with 3GPP TS 38.214 definitions and procedures.

The matrix W_{f} is an N₃×M matrix (where M<N₃) with columns selected from a critically-sampled size-N₃ DFT matrix, as follows:

$${W}_{f} = [ \begin{matrix}{f}_{{k}_{0}} & {f}_{{k}_{0}} & … & {f}_{{M}^{′} - 1}\end{matrix} ] , \qquad 0 \leq {k}_{i} \leq {N}_{3} - 1$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T}$$

Only the indices of the L selected columns of B are reported, along with the oversampling index taking on O₁O₂ values. Similarly, for W_{f}, only the indices of the M selected columns out of the predefined size-N; DFT matrix are reported. In the sequel the indices of the M dimensions are referred as the selected FD basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independently for different transmission layers.

Amplitude (i.e., magnitude) and phase values of an approximately β fraction of the 2LM available coefficients are reported to the gNB (β<1) as part of the CSI report. Note that coefficients with zero magnitude are indicated via a per-transmission layer bitmap. Since all coefficients reported within a transmission layer are normalized with respect to the coefficient with the largest magnitude (strongest coefficient), the relative value of that coefficient is set to unity (i.e., one), and no magnitude or phase information is explicitly reported for this coefficient. Only an indication of the index of the strongest coefficient per transmission layer is reported. Hence, amplitude and phase values of a maximum of [2βLM]−1 coefficients (along with the indices of selected L, M DFT vectors) are reported per transmission layer, leading to significant reduction in CSI report size, compared with reporting 2N₁N₂×N₃−1 coefficients' information of a theoretical design.

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and UE configured with higher layer parameter codebookType set to ‘typeII-r16’.

The values of N₁ and N₂ are configured with the higher layer parameter n1-n2-codebookSubsetRestriction-r16. The supported configurations of (N₁, N₂) for a given number of CSI-RS ports and the corresponding values of (O₁, O₂) are given in Table 5.2.2.2.1-2 of 3GPP TS 38.214. The number of CSI-RS ports, P_{CSI-RS}, is 2N₁N₂.

The values of L, β and p_{υ} are determined by the higher layer parameter paramCombination-r16, where the mapping is given in Table 8 (taken from Table 5.2.2.2.5-1 of 3GPP TS 38.214).

The UE is not expected to be configured with paramCombination-r16 equal to: 3, 4, 5, 6, 7, or 8 when P_{CSI-RS}=4:7 or 8 when P_{CSI-RS}<32:7 or 8 when higher layer parameter typeII-RI-Restriction-r16 is configured with rᵢ=1 for any i>1:7 or 8 when R=2.

The parameter R is configured with the higher-layer parameter numberOfPMISubbandsPerCQISubband-r16. This parameter controls the total number of precoding matrices N₃ indicated by the PMI as a function of the number of configured subbands in csi-ReportingBand, the subband size configured by the higher-level parameter subbandSize and of the total number of PRBs in the bandwidth part according to Table 5.2.1.4-2 of 3GPP TS 38.214, as follows:

When R=1: One precoding matrix is indicated by the PMI for each subband in csi-ReportingBand.

When R=2: For each subband in csi-ReportingBand that is not the first or last subband of a BWP, two precoding matrices are indicated by the PMI: the first precoding matrix corresponds to the first

$${N}_{PRB}^{SB} / 2$$

PRBs of the subband and the second precoding matrix corresponds to the last

$${N}_{PRB}^{SB} / 2$$

PRBs of the subband.

For each subband in csi-ReportingBand that is the first or last subband of a BWP: If

$$( {N}_{BWP , i}^{start} mod {N}_{PRB}^{SB} ) \geq \frac{{N}_{PRB}^{SB}}{2} ,$$

one precoding matrix is indicated by the PMI corresponding to the first subband. If

$$( {N}_{BWP , i}^{start} mod {N}_{PRB}^{SB} ) < \frac{{N}_{PRB}^{SB}}{2} ,$$

two precoding matrices are indicated by the PMI corresponding to the first subband: the first precoding matrix corresponds to the first

$$\frac{{N}_{PRB}^{SB}}{2} - ( {N}_{BWP , i}^{start} mod {N}_{PRB}^{SB} )$$

PRBs of the first subband and the second precoding matrix corresponds to the last

$$\frac{{N}_{PRB}^{SB}}{2}$$

PRBs of the first subband.

If

$$1 + ( {N}_{BWP , i}^{start} + {N}_{BWP , i}^{s i z e} - 1 ) mod {N}_{PRB}^{SB} \leq \frac{{N}_{PRB}^{SB}}{2} ,$$

one precoding matrix is indicated by the PMI corresponding to the last subband. If

$$1 + ( {N}_{BWP , i}^{start} + {N}_{BWP , i}^{s i z e} - 1 ) mod {N}_{PRB}^{SB} > \frac{{N}_{PRB}^{SB}}{2} ,$$

two precoding matrices are indicated by the PMI corresponding to the last subband: the first precoding matrix corresponds to the first

$$\frac{{N}_{PRB}^{SB}}{2}$$

PRBs of the last subband and the second precoding matrix corresponds to the last

$$1 + ( {N}_{BWP , i}^{start} + {N}_{BWP , i}^{s i z e} - 1 ) mod {N}_{PRB}^{SB} - \frac{{N}_{PRB}^{SB}}{2}$$

PRBs of the last subband.

TABLE 8
Codebook parameter configurations for L, β and p_{υ}

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The UE shall report the RI value v according to the configured higher layer parameter typeII-RI-Restriction-r16. The UE shall not report υ>4.

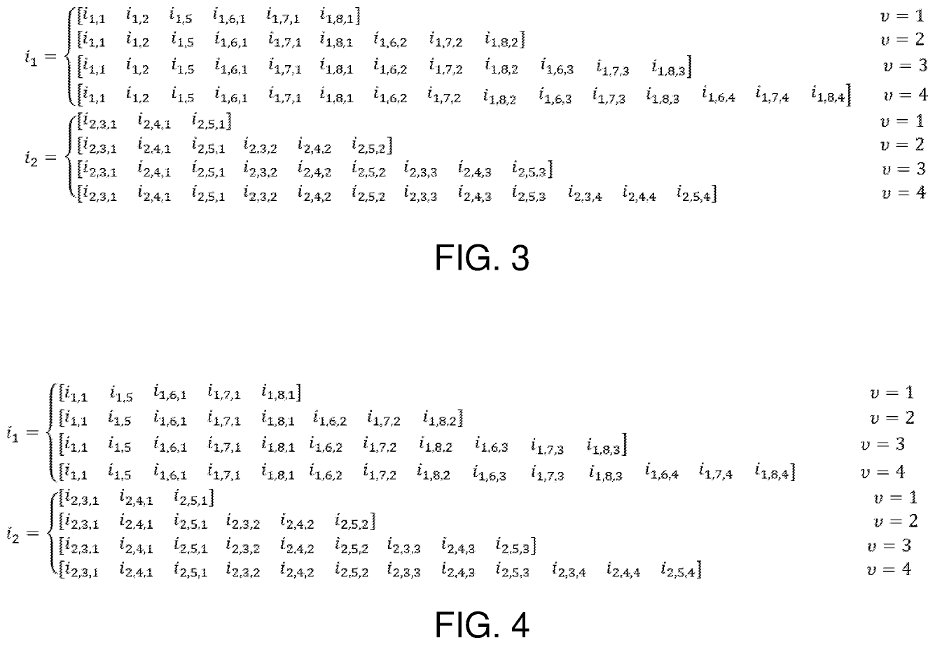

The PMI value corresponds to the codebook indices of i₁ and i₂ depicted in FIG. 3.

The precoding matrices indicated by the PMI are determined from L+M_{υ} vectors.

L vectors,

$${v}_{{m}_{1}^{( i )} , {m}_{2}^{( i )}} , i = 0 , 1 , … , L - 1 ,$$

are identified by the indices q₁, q₂, n₁, n₂, indicated by i_{1,1}, i_{1,2}, obtained as in 5.2.2.2.3, where the values of C(x, y) are given in Table 11 (taken from Table 5.2.2.2.5-4 of 3GPP TS 38.214).

$$\begin{matrix}{M}_{v} = ⌈ {p}_{v} \frac{{N}_{3}}{R} ⌉ vectors , {[ {y}_{0 , l}^{( f )} , {y}_{1 , l}^{( f )} , … , {y}_{{N}_{3} - 1 , l}^{( f )} ]}^{T} , f = 0 , 1 , … , {M}_{v} - 1 , are identified by {M}_{i n i t i a l} ( for {N}_{3} > 19 ) and {n}_{3 , l} ( l = 1 , … , v ) \\ where \\ {M}_{i n i t i a l} ∈ \{ - 2 {M}_{v} + 1 , - 2 {M}_{v} + 2 , … , 0 \} \\ {n}_{3 , l} = [ {n}_{3 , l}^{( 0 )} , … , {n}_{3 , l}^{( {M}_{v} - 1 )} ] \\ {n}_{3 , l}^{( f )} ∈ \{ 0 , 1 , … , {N}_{3} - 1 \}\end{matrix}$$

which are indicated by means of the indices i_{1,5} (for N₃>19) and i_{1,6,l} (for M_{υ}>1 and l=1, . . . , υ), where

$$\begin{matrix}{i}_{1 , 5} ∈ \{ 0 , 1 , … , 2 {M}_{v} - 1 \} \\ {i}_{1 , 6 , l} ∈ \{ \begin{matrix}\{ 0 , 1 , … , ( \begin{matrix}{N}_{3} - 1 \\ {M}_{v} - 1\end{matrix} ) - 1 \} & {N}_{3} \leq 19 \\ \{ 0 , 1 , … , ( \begin{matrix}2 {M}_{v} - 1 \\ {M}_{v} - 1\end{matrix} ) - 1 \} & {N}_{3} > 19\end{matrix}\end{matrix}$$

The amplitude coefficient indicators i_{2,3,l} and i_{2,4,l} are

$$\begin{matrix}{i}_{2 , 3 , l} = [ {k}_{l , 0}^{( 1 )} {k}_{l , 1}^{( 1 )} ] \\ {i}_{2 , 4 , l} = [ {k}_{l , 0}^{( 2 )} … {k}_{l , {M}_{v} - 1}^{( 2 )} ] \\ {k}_{l , f}^{( 2 )} = [ {k}_{l , 0 , f}^{( 2 )} … {k}_{l , 2 L - 1 , f}^{( 2 )} ] \\ {k}_{l , p}^{( 1 )} ∈ \{ 1 , … , 15 \} \\ {k}_{l , i , f}^{( 2 )} ∈ \{ 0 , … , 7 \}\end{matrix}$$

for l=1, . . . , υ.

The phase coefficient indicator i_{2,5,l} is

$$\begin{matrix}{i}_{2 , 5 , l} = [ {c}_{l , 0} … {c}_{l , {M}_{v} - 1} ] \\ {c}_{l , f} = [ {c}_{l , 0 , f} … {c}_{l , 2 L - 1 , f} ] \\ {c}_{l , i , f} ∈ \{ 0 , … , 15 \}\end{matrix}$$

for l=1, . . . , υ.

Let K₀=[β₂LM₁]. The bitmap whose nonzero bits identify which coefficients in i_{2,4,l} and i_{2,5,l} are reported, is indicated by i_{1,7,l}

$$\begin{matrix}{i}_{1 , 7 , l} = [ {k}_{l , 0}^{( 3 )} … {k}_{l , {M}_{v} - 1}^{( 3 )} ] \\ {k}_{l , f}^{( 3 )} = [ {k}_{l , 0 , f}^{( 3 )} … {k}_{l , 2 L - 1 , f}^{( 3 )} ] \\ {k}_{l , i , f}^{( 3 )} ∈ \{ 0 , 1 \}\end{matrix}$$

for layer l=1, . . . , υ, such that

$${K}_{l}^{N Z} = {\sum }_{i = 0}^{2 L - 1} {\sum }_{f = 0}^{{M}_{v} - 1} {k}_{l , i , f}^{( 3 )} \leq {K}_{0}$$

is the number of nonzero coefficients for layer l=1, . . . , υ and

$${K}^{N Z} = {\sum }_{l = 1}^{v} {K}_{l}^{N Z} \leq 2 {K}_{0}$$

is the total number of nonzero coefficients.

The indices of i_{2,4,l}, i_{2,5,l} and i_{1,7,l} are associated to the M_{υ} codebook indices in n_{3,l}.

The mapping from

$${k}_{l , p}^{( 1 )}$$

to the amplitude coefficient

$${p}_{l , p}^{( 1 )}$$

is given in Table 9 (taken from Table 5.2.2.2.5-2 of 3GPP TS 38.214) and the mapping from

$${k}_{l , i , f}^{( 2 )}$$

to the amplitude coefficient

$${p}_{l , i , f}^{( 2 )}$$

is given in Table 10 (taken from Table 5.2.2.2.5-3 of 3GPP TS 38.214). The amplitude coefficients are represented by

$${p}_{l}^{( 1 )} = [ \begin{matrix}{p}_{l , 0}^{( 0 )} & {p}_{l , 1}^{( 1 )}\end{matrix} ]$$

$${p}_{l}^{( 2 )} = [ \begin{matrix}{p}_{l , 0}^{( 2 )} & … & {p}_{l , {M}_{v} - 1}^{( 2 )}\end{matrix} ]$$

$${p}_{l , f}^{( 2 )} = [ \begin{matrix}{p}_{l , 0 , f}^{( 2 )} & … & {p}_{l , 2 L - 1 , f}^{( 2 )}\end{matrix} ]$$

for l=1, . . . , υ.

Let

$${f}_{l}^{*}$$

∈{0, 1, . . . , M_{υ}−1} be the index of i_{2,4,l} and

$${i}_{l}^{*}$$

∈{0, 1, . . . , 2L−1} be the index of

$${k}_{l , {f}_{l}^{*}}^{( 2 )}$$

which identify the strongest coefficient of layer l, i.e., the element

$${k}_{l , {i}_{l}^{*} , {f}_{l}^{*}}^{( 2 )}$$

of i_{2,4,l}, for l=1, . . . , υ. The codebook indices of n_{3,l} are remapped with respect to

$${n}_{3 , l}^{( {f}_{l}^{*} )}$$

as

$${n}_{3 , l}^{( f )} = ( {n}_{3 , l}^{( f )} - {n}_{3 , l}^{( {f}_{l}^{*} )} )$$

mod N₃, such that

$${n}_{3 , l}^{( {f}_{l}^{*} )} = 0 ,$$

after remapping. The index f is remapped with respect to

$${f}_{l}^{*}$$

as

$$f = ( f - {f}_{l}^{*} ) mod {M}_{υ} ,$$

such that the index of the strongest coefficient is

$${f}_{i}^{*} = 0$$

(l=1, . . . , υ), after remapping. The indices of i_{2,4,l}, i_{2,5,l} and i_{1,7,l} indicate amplitude coefficients, phase coefficients and bitmap after remapping.

The strongest coefficient of layer l is identified by i_{1,8,l}∈{0, 1, . . . , 2L−1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq 4\end{matrix}$$

for l=1, . . . , υ.

TABLE 9
$Mapping of elements of {i}_{2 , 3 , l} : {k}_{l , p}^{( 1 )} to {p}_{l , p}^{( 1 )}$

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ( l = 1 , … , υ )$$

The indicators

$${k}_{l , ⌊ \frac{{i}_{l}^{*}}{L} ⌋}^{( 1 )} , {k}_{l , {i}_{l}^{*} , 0}^{( 2 )} and {c}_{l , {i}_{l}^{*} , 0}$$

are not reported for l=1, . . . , υ.

The indicator

$${k}_{l , ( ⌊ \frac{{i}_{l}^{*}}{L} ⌋ + 1 ) mod 2}^{( 1 )}$$

is reported for l=1, . . . , υ.

The K^{NZ}−υ indicators

$${k}_{l , i , f}^{( 2 )}$$

for which

$${k}_{l , i , f}^{( 3 )} = 1 ,$$

l≠l*ᵢ, f≠0 are reported.

The K^{NZ}−υ indicators c_{l,i,f} for which

$${k}_{l , i , f}^{( 3 )} = 1 ,$$

i≠i*ₗ, f≠0 are reported.

The remaining 2L·Mᵥ·v−K^{NZ} indicators

$${k}_{l , i , f}^{( 2 )}$$

are not reported.

The remaining 2L·Mᵥ·v−K^{NZ} indicators c_{l,i,f} are not reported.

TABLE 10
$Mapping of elements of {i}_{2 , 4 , l} : {k}_{l , i , f}^{( 2 )} to {p}_{l , i , f}^{( 2 )}$

| ${k}_{l , i , f}^{( 2 )}$ | ${p}_{l , i , f}^{( 2 )}$ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

The elements of n₁ and n₂ are found from i_{1,2} using the algorithm described in 5.2.2.2.3 of 3GPP TS 38.214, where the values of C(x, y) are given in Table 11.

For N₃>19, Mᵢₙᵢₜᵢₐₗ is identified by i_{1,5}.

For all values of N₃,

$${n}_{3 , l}^{( 0 )} = 0$$

for l=1, . . . , υ. If M_{υ}>1, the nonzero elements of n_{3,l}, identified by

$${n}_{3 , l}^{( 1 )} , … , {n}_{3 , l}^{( {M}_{v} - 1 )} ,$$

are found from i_{1,6,l}(l=1, . . . , υ), for N₃≤19, and from i_{1,6,l} (l=1, . . . , υ) and Mᵢₙᵢₜᵢₐₗ, for N₃>19, using C(x, y) as defined in Table 11 and the algorithm:

$${s}_{0} = 0$$

for f=1, . . . , M_{υ}−1

Find the largest x*∈{M_{υ}−1−f . . . , N₃−1−f} in Table 11 such that

```
i_{1,6,l} − s_{f-1} ≥ C(x^{*}, M_{υ} − f)
  e_{f} = C(x^{*}, M_{υ} − f)
    s_{f} = s_{f-1} + e_{f}
    if N₃ ≤ 19
    ${n}_{3 , l}^{( f )} = {N}_{3} - 1 - {x}^{*}$
      else
    ${n}_{l}^{( f )} = 2 {M}_{υ} - 1 - {x}^{*}$
  $if {n}_{l}^{( f )} \leq {M}_{initial} + 2 {M}_{υ} - 1$
        ${n}_{3 , l}^{( f )} = {n}_{l}^{( f )}$
        else
    ${n}_{3 , l}^{( f )} = {n}_{l}^{( f )} + ( {N}_{3} - 2 {M}_{υ} )$
        end if
  end if
```

TABLE 11
Combinatorial coefficients C(x, y)

| | y | | | | | | | | |
|---|---|---|---|---|---|---|---|---|---|
| x | 1 | 2 | 3 | 4 | 5 | 6 | 7 | 8 | 9 |
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

When n_{3,l} and Mᵢₙᵢₜᵢₐₗ are known, i_{1,5} and i_{1,6,l}(l=1, . . . , υ) are found as follows:

If N₃≤19, i_{1,5}=0 and is not reported. If Mᵥ=1, i_{1,6,l}=0, for l=1, . . . , v, and is not reported. If Mᵥ>1,

$${i}_{1 , 6 , l} = {\sum }_{f = 1}^{{M}_{v} - 1} C ( {N}_{3} - 1 - {n}_{3 , l}^{( f )} , {M}_{v} - f ) ,$$

where C(x, y) is given in Table 5.2.2.2.5-4 and where the indices f=1, . . . , M_{υ}−1 are assigned such that

$${n}_{3 , l}^{( f )}$$

increases as f increases.

If N₃>19, Mᵢₙᵢₜᵢₐₗ is indicated by i_{1,5}, which is reported and given by

$${i}_{1 , 5} = \{ \begin{matrix}{M}_{initial} & {M}_{initial} = 0 \\ {M}_{initial} + 2 {M}_{v} & {M}_{initial} < 0\end{matrix}$$

Only the nonzero indices

$${n}_{3 , l}^{( f )} ∈ lntS ,$$

where IntS={(Mᵢₙᵢₜᵢₐₗ+i) mod N₃, i=0, 1, . . . , 2 M_{υ}−1}, are reported, where the indices f=1, . . . , M_{υ}−1 are assigned such that

$${n}_{3 , l}^{( f )}$$

increases as f increases. Let

$${n}_{l}^{( f )} = \{ \begin{matrix}{n}_{3 , l}^{( f )} & {n}_{3 , l}^{( f )} \leq {M}_{initial} + 2 {M}_{v} - 1 \\ {n}_{3 , l}^{( f )} - ( {N}_{3} - 2 {M}_{v} ) & {n}_{3 , l}^{( f )} > {M}_{initial} + {N}_{3} - 1\end{matrix} ,$$

then

$${i}_{1 , 6 , l} = {\sum }_{f = 1}^{{M}_{v} - 1} C ( 2 {M}_{v} - 1 - {n}_{l}^{( f )} , {M}_{v} - f ) ,$$

where C(x, y) is given in Table 5.2.2.2.5-4.

The codebooks for 1-4 layers are given in Table 12 (taken from Table 5.2.2.2.5-5 of 3GPP TS 38.214, where

$${m}_{1}^{( i )} , {m}_{2}^{( i )} ,$$

for i=0,1, . . . , L-1,

$${v}_{{m}_{1}^{( i )} , {m}_{2}^{( i )}}$$

are obtained as in CLause 5.2.2.2.3 of 3GPP TS 38.214, and the quantities φ_{l,i,f} and y_{t,l} are given by

$${φ}_{l , i , f} = {e}^{j \frac{2 π {c}_{l , i , f}}{16}}$$

$${y}_{t , l} = [ \begin{matrix}{y}_{t , l}^{( 0 )} & {y}_{t , l}^{( 1 )} & ⋯ & {y}_{t , l}^{( {M}_{v} - 1 )}\end{matrix} ]$$

where t={0, 1, . . . , N₃−1}, is the index associated with the precoding matrix, l={1, . . . , υ}, and with

$${y}_{t , l}^{( f )} = {e}^{j \frac{2 π {tn}_{3 , l}^{( f )}}{{N}_{3}}}$$

for f=0, 1, . . . , M_{υ}−1.

TABLE 12
Codebook for 1-layer. 2-layer, 3-layer and 4-layer CSI reporting
using antenna ports 3000 to 2999 + PCSI-RS

| Layers | |
|---|---|
| υ = 1 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{( 1 )} = {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} =$ |
| υ = 2 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} =$ |
| | $\frac{1}{\sqrt{2}} [ \begin{matrix}{W}_{{q}_{1} , {q}_{2} , {n}_{1} , {n}_{2} , {n}_{3 , 1} {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} {p}_{2}^{( 1 )} , {p}_{2}^{( 2 )} , {i}_{2 , 5 , 2} , t}^{2}\end{matrix} ]$ |
| υ = 3 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} =$ |
| | $= \frac{1}{\sqrt{3}} [ \begin{matrix}{W}_{{q}_{1} , {q}_{2} , {n}_{1} , {n}_{2} , {n}_{3 , 1} {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} {p}_{2}^{( 1 )} , {p}_{2}^{( 2 )} , {i}_{2 , 5 , 2} , t}^{2} {W}_{{q}_{1} , {q}_{2} , {n}_{1} , {n}_{2} , {n}_{3 , 2} {p}_{3}^{( 1 )} , {p}_{3}^{( 2 )} , {i}_{2 , 5 , 3}}^{3} \text{?}\end{matrix}$ |
| υ = 4 | ${W}_{{q}_{1} , {q}_{2} , {n}_{1} , {n}_{2} , {n}_{3 , 1} {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} =$ |
| | $\frac{1}{2} [ \begin{matrix}{W}_{{q}_{1} , {q}_{2} , {n}_{1} , {n}_{2} , {n}_{3 , 1} {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} {p}_{2}^{( 1 )} , {p}_{2}^{( 2 )} , {i}_{2 , 5 , 2} , t}^{2} & {W}_{{q}_{1} , {q}_{2} , {n}_{1} , {n}_{2} , {n}_{3 , 3} {p}_{3}^{( 1 )} , {p}_{3}^{( 2 )} , {i}_{2 , 5 , 3} , t}^{3}\end{matrix} \text{?}$ |

$Where {W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$
and the mappings from i₁ to q₁, q₂, n₁, n₂, n_{3,1}, n_{3,2}, n_{3,3}, n_{3,4}, and from i₂ to i_{2,5,1}, i_{2,5,2},
${i}_{2 , 5 , 3} , {i}_{2 , 5 , 4} , {p}_{1}^{( 1 )} , {p}_{2}^{( 1 )} , {p}_{3}^{( 1 )} and {p}_{4}^{( 1 )} , {p}_{1}^{( 2 )} , {p}_{2}^{( 2 )} , {p}_{3}^{( 2 )} and {p}_{4}^{( 2 )} are as described above , including$
the ranges of the constituent indices of i₁ and i₂.
$\text{?} \text{indicates text missing or illegible when filed}$

For coefficients with

$${k}_{l , i , f}^{( 3 )} = 0 ,$$

amplitude and phase are set to zero, i.e.,

$${p}_{l , i , {f}^{= 0}}^{( 2 )}$$

and φ_{l,i,f}=0.

The bitmap parameter typeII-RI-Restriction-r16 forms the bit sequence r₃, r₂, r₁, r₀ where r₀ is the LSB and r₃ is the MSB. When rᵢ is zero, i∈{0,1, . . . , 3}, PMI and RI reporting are not allowed to correspond to any precoder associated with υ=i+1 layers.

The bitmap parameter n1-n2-codebookSubsetRestriction-r16 forms the bit sequence B=B₁B₂ and configures the vector group indices g^{(k)} as in Clause 5.2.2.2.3 of 3GPP TS 38.214. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude, γ_{i+pL} (p=0,1), with i∈{0, 1, . . . , L−1}, of the coefficients associated with the vector in group g^{(k)} indexed by x₁, x₂, where the maximum amplitudes are given in Table 13 (taken from Table 5.2.2.2.5-6 of 3GPP TS 38.214) and the average coefficient amplitude is restricted as follows

$$\sqrt{\frac{1}{{\sum }_{f = 0}^{{M}_{υ} - 1} {k}_{l , i + pL , f}^{( 3 )}} {\sum }_{f = 0}^{{M}_{υ} - 1} {{k}_{l , i + pL , f}^{( 3 )} ( {p}_{l , p}^{( 1 )} {p}_{l , i + pL , f}^{( 2 )} )}^{2}} \leq {γ}_{i + p L}$$

for l=1, . . . , υ, and μ=0,1. A UE that does not report the parameter amplitudeSubsetRestriction=‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01$$

or 10.

TABLE 13
Maximum allowed average coefficient amplitudes for restricted vectors

| Bit | Maximum |
|---|---|
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Average Coefficient Amplitude γ_{i+pL} |
| 00 | 0 |
| 01 | \sqrt{1/4} |
| 10 | \sqrt{1/2} |
| 11 | 1 |

Regarding 3GPP NR Rel-16, for Type-II PS codebook, only K beamformed CSI-RS ports are utilized in DL transmission (where K≤2N₁N₂), in order to reduce complexity. The K×N₃ codebook matrix per transmission layer takes on the form:

$$W = {W}_{1}^{PS} {\tilde{W}}_{2} {W}_{f}^{H}$$

where the superscript ^{H} denotes a matrix Hermitian, i.e., conjugate transposition operator.

Here, \tilde{W}₂ and \tilde{W}_{f} follow the same structure as the conventional NR Rel-16 Type-II Codebook, described above, where both are transmission layer specific. The matrix

$${W}_{1}^{PS}$$

is a K×2L block-diagonal matrix with the same structure as that in the NR Rel-15 Type-II PS Codebook, described above.

In more detail, the specification for the NR Rel-16 Type-II Port Selection Codebook is as follows:
For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebook Type set to ‘typeII-PortSelection-r16’.

The number of CSI-RS ports is configured as in Clause 5.2.2.2.4 of 3GPP TS 38.214.

The value of d is configured with the higher layer parameter portSelectionSamplingSize-r16, where d∈{1,2, 3, 4} and d≤L.

The values L, β and p_{υ} are configured as in Clause 5.2.2.2.5 of 3GPP TS 38.214, where the supported configurations are given in Table 14 (taken from Table 5.2.2.2.6-1 of 3GPP TS 38.214).

TABLE 14
Codebook parameter configurations for L, β andp_{υ}

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

The UE shall report the RI value u according to the configured higher layer parameter typeII-PortSelectionRI-Restriction-r₁₆. The UE shall not report υ>4.

The values of R is configured as in Clause 5.2.2.2.5 of 3GPP TS 38.214.

The UE is also configured with the higher layer bitmap parameter typeII-PortSelectionRI-Restriction-r16, which forms the bit sequence r₃, r₂, r₁, r₀, where r₀ is the LSB and r₃ is the MSB. When r₁ is zero, i∈{0, 1, . . . , 3}, PMI and RI reporting are not allowed to correspond to any precoder associated with υ=i+1 layers.

The PMI value corresponds to the codebook indices i₁ and i₂ depicted in FIG. 4. The 2L antenna ports are selected by the index i_{1,1} as in Clause 5.2.2.2.4 of 3GPP TS 38.214.

Parameters N₃, My, Mᵢₙᵢₜᵢₐₗ (for N₃>19) and K₀ are defined as in Clause 5.2.2.2.5 of 3GPP TS 38.214.

For layer l, l=1, . . . , υ, the strongest coefficient i_{1,8,l}, the amplitude coefficient indicators i_{2,3,l} and i_{2,4,l}, the phase coefficient indicator i_{2,5,l} and the bitmap indicator i_{1,7,l} are defined and indicated as in Clause 5.2.2.2.5 of 3GPP TS 38.214, where the mapping from

$${k}_{l , p}^{( 1 )}$$

to the amplitude coefficient

$${p}_{l , p}^{( 1 )}$$

is given in Table 9 and the mapping from

$${k}_{l , i , f}^{( 2 )}$$

to the amplitude coefficient

$${p}_{l , i , f}^{( 2 )}$$

is given in Table 10.

The number of nonzero coefficients for layer l,

$${K}_{l}^{N Z} ,$$

and the total number or nonzero coefficients K^{NZ} are defined as in Clause 5.2.2.2.5.

The amplitude coefficients

$${p}_{l}^{( 1 )} and {p}_{l}^{( 2 )}$$

(l=1, . . . , υ) are represented as in Clause 5.2.2.2.5 of 3GPP TS 38.214.

The amplitude and phase coefficient indicators are reported as in Clause 5.2.2.2.5 of 3GPP TS 38.214.

Codebook indicators i_{1,5} and i_{1,6,l} (l=1, . . . , υ) are found as in Clause 5.2.2.2.5 of 3GPP TS 38.214.

The codebooks for 1-4 layers are given in Table 15 (taken from Table 5.2.2.2.6-2 of 3GPP TS 38.214), where vₘ is a P_{CSI-RS}/2-element column vector containing a value of 1 in element (m mod P_{CSI-RS}/2) and zeros elsewhere (where the first element is element 0), and the quantities φ_{l,i,f} and y_{t,l} are defined as in Clause 5.2.2.2.5 of 3GPP TS 38.214.

TABLE 15
Codebook for 1-layer. 2-layer, 3-layer and 4-layer CSI reporting
using antenna ports 3000 to 2999 + PCSI-RS

| Layers | |
|---|---|
| υ = 1 | ${W}_{{i}_{1 , 1} , {n}_{3 , 1} {p}_{1}^{( 1 )} , {p}_{1}^{( 2 )} , {i}_{2 , 5 , 1} , t}^{( 1 )} = {W}_{{i}_{1 , 1} , {n}_{3 , 1} , {p}_{1}^{( 1 )} , {p}_{1}^{( 2 )} , {i}_{2 , 5 , 1} , t}^{1}$ |
| υ = 2 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2} ]\end{matrix}$ |
| υ = 3 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} =$ |
| | $\frac{1}{\sqrt{3}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2} & {W}_{{i}_{1 , 1} , {n}_{3 , 3} , {p}_{3}^{( 1 )} , {p}_{3}^{( 2 )} , {i}_{2 , 5 , 3} , t}^{3} ]\end{matrix}$ |
| υ = 4 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} =$ |
| | $\frac{1}{2} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2} & {W}_{{i}_{1 , 1} , {n}_{3 , 3} , {p}_{3}^{( 1 )} , {p}_{3}^{( 2 )} , {i}_{2 , 5 , 3} , t}^{3} & {W}_{{i}_{1 , 1} , {n}_{3 , 4} , {p}_{4}^{( 1 )} , {p}_{3}^{( 2 )} , {i}_{2 , 5}}^{4}\end{matrix} \text{?}$ |

$Where {W}_{{i}_{1 , 1} , {n}_{3} , {p}_{l}^{( 1 )} , {p}_{l}^{( 2 )} , {i}_{2 , 5 , l} , t}^{l} = \frac{1}{\sqrt{{γ}_{t , l}}} [ \begin{matrix}{\sum }_{i = 0}^{L - 1} {v}_{{i}_{1 , 1} d + i} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} \\ {\sum }_{i = 0}^{L - 1} {v}_{{i}_{1 , 1} d + i} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {ϕ}_{l , i , f} \vert}^{2}$
and the mappings from i₁ to i_{1,1}, n_{3,1}, n_{3,2}, n_{3,3}, n_{3,4}, and from i₂ to i_{2,5,1}, i_{2,5,2}, i_{2,5,3}, i_{2,5,4},
${p}_{1}^{( 1 )} , {p}_{2}^{( 1 )} , {p}_{3}^{( 1 )} and {p}_{4}^{( 1 )} , {p}_{1}^{( 2 )} , {p}_{2}^{( 2 )} , {p}_{3}^{( 2 )} and {p}_{4}^{( 2 )} are as described above including the ranges$
of the constituent indices of i₁ and i₂.
$\text{?} \text{indicates text missing or illegible when filed}$

For coefficients with

$${k}_{l , i , f}^{( 3 )} = 0 ,$$

amplitude and phase are set to zero, i.e.,

$${p}_{l , i , f}^{( 2 )} = 0$$

and φ_{l,i,f}=0.

The 3GPP NR Rel-17 Type-II Port Selection codebook follows a similar structure as that of Rel-15 and Rel-16 port-selection codebooks, as follows:

$${W}_{l} = {\overline{W}}_{1}^{PS} {\tilde{W}}_{2 , l} {W}_{f , l}^{H} .$$

However, unlike Rel-15 and Rel-16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers.

Here, \tilde{W}_{2,1} and W_{f,l} follow the same structure as the conventional NR Rel-16 Type-II Codebook, however M is limited to 1,2 only, with the network configuring a window of size N={2,4} for M=2. Moreover, the bitmap is reported unless β=1 and the UE reports all the coefficients for a rank up to a value of two.

Regarding UL NR transmission, up to Rel. 16 NR, two transmission modes exist for precoded PUSCH transmission: codebook-based transmission and non-codebook-based transmission. A summary describing both modes is provided below.

For codebook based transmission, PUSCH can be scheduled by DCI format 0_0, DCI format 0_1, DCI format 0_2 or semi-statically configured to operate according to Clause 6.1.2.3 of 3GPP TS 38.214. If this PUSCH is scheduled by DCI format 0_1, DCI format 0_2, or semi-statically configured to operate according to Clause 6.1.2.3 of 3GPP TS 38.214, the UE determines its PUSCH transmission precoder based on SRI, TPMI and the transmission rank, where the SRI, TPMI and the transmission rank are given by DCI fields of SRS resource indicator and Precoding information and number of layers in clause 7.3.1.1.2 and 7.3.1.1.3 of 3GPP TS 38.212 for DCI format 0_1 and 0_2 or given by srs-ResourceIndicator and precodingAndNumberOfLayers according to clause 6.1.2.3 of 3GPP TS 38.214.

The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListForDCI-Format0-2-r16 in SRS-config, respectively.

The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of 3GPP TS 38.211. When the UE is configured with the higher layer parameter txConfig set to ‘codebook’, the UE is configured with at least one SRS resource.

The indicated SRI in slot n is associated with the most recent transmission of SRS resource identified by the SRI, where the SRS resource is prior to the PDCCH carrying the SRI.

For codebook based transmission, the UE determines its codebook subsets based on TPMI and upon the reception of higher layer parameter codebookSubset in pusch-Config for PUSCH associated with DCI format 0_1 and codebookSubsetForDCI-Format0-2-r16 in pusch-Config for PUSCH associated with DCI format 0_2 which may be configured with ‘fully AndPartialAndNonCoherent’, or ‘partialAndNonCoherent’, or ‘nonCoherent’ depending on the UE capability.

When higher layer parameter ul-FullPowerTransmission-r16 is set to ‘fullpowerMode2’ and the higher layer parameter codebookSubset or the higher layer parameter codebookSubsetForDCI-Format0-2-r16 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebookSubset or codebookSubsetForDCI-Format0-2-r16 with ‘fully AndPartialAndNonCoherent’.

A UE reporting its UE capability of ‘nonCoherent’ transmission shall not expect to be configured by either codebookSubset or codebookSubsetForDCI-Format0-2-r16 with ‘fully AndPartialAndNonCoherent’ or with ‘partialAndNonCoherent’.

A UE shall not expect to be configured with the higher layer parameter codebookSubset or the higher layer parameter codebook SubsetForDCI-Format0-2-r16 set to ‘partialAndNonCoherent’ when higher layer parameter nrofSRS-Ports in an SRS-ResourceSet with usage set to ‘codebook’ indicates that the maximum number of the configured SRS antenna ports in the SRS-Resource Set is two.

For codebook based transmission, the UE may be configured with a single SRS-ResourceSet with usage set to ‘codebook’ and only one SRS resource can be indicated based on the SRI from within the SRS resource set. Except when higher layer parameter ul-FullPowerTransmission-r16 is set to ‘fullpowerMode 2’, the maximum number of configured SRS resources for codebook based transmission is 2. If aperiodic SRS is configured for a UE, the SRS request field in DCI triggers the transmission of aperiodic SRS resources.

A UE shall not expect to be configured with higher layer parameter ul-FullPowerTransmission-r16 set to ‘fullpowerModel’ and codebook Subset or codebookSubsetForDCI-Format0-2-r16 set to ‘fullAndPartialAndNonCoherent’ simultaneously.

The UE shall transmit PUSCH using the same antenna port(s) as the SRS port(s) in the SRS resource indicated by the DCI format 0_1 or 0_2 or by configuredGrantConfig according to clause 6.1.2.3 of 3GPP TS 38.214.

The DM-RS antenna ports {\tilde{p}₀, . . . , \tilde{p}_{υ-v}} in Clause 6.4.1.1.3 of 3GPP TS 38.211 are determined according to the ordering of DM-RS port(s) given by Tables 7.3.1.1.2-6 to 7.3.1.1.2-23 in Clause 7.3.1.1.2 of 3GPP TS 38.212.

Except when higher layer parameter ul-FullPowerTransmission-r16 is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for all these SRS resources.

When higher layer parameter ul-FullPowerTransmission-r16 is set to ‘fullpowerMode2’, the UE can be configured with one SRS resource or multiple SRS resources with same or different number of SRS ports within an SRS resource set with usage set to ‘codebook’. Up to 2 different spatial relations can be configured for all SRS resources in the SRS resource set with usage set to ‘codebook’ when multiple SRS resources are configured in the SRS resource set. Subject to UE capability, a maximum of 2 or 4 SRS resources are supported in an SRS resource set with usage set to ‘codebook’.

Regarding DCI Format 0_1 3GPP TS 38.212, precoding information and number of layers-number of bits determined by the following:
0 bits if the higher layer parameter txConfig=nonCodeBook;
0 bits for 1 antenna port and if the higher layer parameter txConfig=codebook;
4, 5, or 6 bits according to Table 7.3.1.1.2-2 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank, and codebookSubset;
4 or 5 bits according to Table 7.3.1.1.2-2A of 3GPP TS 38.212 for 4 antenna ports, if txConfig=codebook, ul-FullPowerTransmission-r16=fullpowerModel, maxRank=2, transform precoder is disabled, and according to the values of higher layer parameter codebookSubset;
4 or 6 bits according to Table 7.3.1.1.2-2B of 3GPP TS 38.212 for 4 antenna ports, if txConfig=codebook, ul-FullPowerTransmission-r16=fullpowerModel, maxRank=3 or 4, transform precoder is disabled, and according to the values of higher layer parameter codebookSubset;
2, 4, or 5 bits according to Table 7.3.1.1.2-3 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank, and codebookSubset;
3 or 4 bits according to Table 7.3.1.1.2-3A of 3GPP TS 38.212 for 4 antenna ports, if txConfig codebook, ul-FullPowerTransmission-r16=fullpowerModel, maxRank=1, and according to whether transform precoder is enabled or disabled, and the values of higher layer parameter codebookSubset;
2 or 4 bits according to Table 7.3.1.1.2-4 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank and codebookSubset;
2 bits according to Table 7.3.1.1.2-4A of 3GPP TS 38.212 for 2 antenna ports, if txConfig=codebook, ul-FullPowerTransmission-r16=fullpowerModel, transform precoder is disabled, maxRank=2, and codebookSubset=nonCoherent;
1 or 3 bits according to Table7.3.1.1.2-5 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank and codebookSubset;
2 bits according to Table 7.3.1.1.2-5A of 3GPP TS 38.212 for 2 antenna ports, if txConfig=codebook, ul-FullPowerTransmission-r16=fullpowerModel, maxRank=1, and according to whether transform precoder is enabled or disabled, and the values of higher layer parameter codebookSubset.

For the higher layer parameter txConfig=codebook, if ul-FullPowerTransmission-r16 is configured to fullpowerMode2, maxRank is configured to be larger than 2, and at least one SRS resource with 4 antenna ports is configured in an SRS resource set with usage set to ‘codebook’ and an SRS resource with 2 antenna ports is indicated via SRI in the same SRS resource set, then Table 7.3.1.1.2-4 of 3GPP TS 38.212 is used.

For the higher layer parameter txConfig=codebook, if different SRS resources with different number of antenna ports are configured, the bitwidth is determined according to the maximum number of ports in an SRS resource among the configured SRS resources in an SRS resource set with usage set to ‘codebook’. If the number of ports for a configured SRS resource in the set is less than the maximum number of ports in an SRS resource among the configured SRS resources, a number of most significant bits with value set to ‘0’ are inserted to the field.

Regarding DCI Format 0_2, precoding information and number of layers-number of bits determined by the following:
0 bits if the higher layer parameter txConfig=nonCodeBook;
0 bits for 1 antenna port and if the higher layer parameter txConfig=codebook;
4, 5, or 6 bits according to Table 7.3.1.1.2-2 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2, and codebookSubset-ForDCIFormat0_2;
4 or 5 bits according to Table 7.3.1.1.2-2A of 3GPP TS 38.212 for 4 antenna ports, if txConfig=codebook, ul-FullPowerTransmission-r16=fullpowerModel, the values of higher layer parameters maxRankForDCI-Format0-2=2, transform precoder is disabled, and according to the value of higher layer parameter codebookSubsetForDCI-Format0-2;
4 or 6 bits according to Table 7.3.1.1.2-2B of 3GPP TS 38.212 for 4 antenna ports, if txConfig=codebook, ul-FullPowerTransmission-r16=fullpowerModel, the values of higher layer parameters maxRankForDCI-Format0-2=3 or 4, transform precoder is disabled, and according to the value of higher layer parameter codebookSubsetForDCI-Format0-2;
2, 4, or 5 bits according to Table 7.3.1.1.2-3 of 3GPP TS 38.212 for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2, and codebookSubset-ForDCIFormat0_2;
3 or 4 bits according to Table 7.3.1.1.2-3A of 3GPP TS 38.212 for 4 antenna ports, if txConfig=codebook, ul-FullPowerTransmission-r16=fullpowerModel, maxRankForDCI-Format0-2=1, and according to whether transform precoder is enabled or disabled, and the value of higher layer parameter codebookSubsetForDCI-Format0-2;
2 or 4 bits according to Table 7.3.1.1.2-4 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2 and codebookSubset-ForDCIFormat0_2;
2 bits according to Table 7.3.1.1.2-4A of 3GPP TS 38.212 for 2 antenna ports, if txConfig=codebook, ul-FullPowerTransmission-r16=fullpowerModel, transform precoder is disabled, the maxRankForDCI-Format0-2=2, and codebookSubsetForDCI-Format0-2=nonCoherent;
1 or 3 bits according to Table7.3.1.1.2-5 of 3GPP TS 38.212 for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2 and codebookSubset-ForDCIFormat0_2;
2 bits according to Table 7.3.1.1.2-5A of 3GPP TS 38.212 for 2 antenna ports, if txConfig=codebook, ul-FullPowerTransmission-r16=fullpowerModel, maxRankForDCI-Format0-2=1, and according to whether transform precoder is enabled or disabled, and the value of higher layer parameter codebookSubsetForDCI-Format0-2.

For the higher layer parameter txConfig=codebook, if ul-FullPowerTransmission-r16 is configured to fullpowerMode2, the values of higher layer parameters maxRankForDCI-Format0-2 is configured to be larger than 2, and at least one SRS resource with 4 antenna ports is configured in an SRS resource set with usage set to ‘codebook’ and an SRS resource with 2 antenna ports is indicated via SRI in the same SRS resource set, then Table 7.3.1.1.2-4 of 3GPP TS 38.212 is used.

For the higher layer parameter txConfig=codebook, if different SRS resources with different number of antenna ports are configured, the bitwidth is determined according to the maximum number of ports in an SRS resource among the configured SRS resources in an SRS resource set with usage set to ‘codebook’. If the number of ports for a configured SRS resource in the set is less than the maximum number of ports in an SRS resource among the configured SRS resources, a number of most significant bits with value set to ‘0’ are inserted to the field.

Regarding precoding, the block of vectors

$${[ {y}^{( 0 )} ( i ) … {y}^{( υ - 1 )} ( i ) ]}^{T} ,$$

i=0, 1, . . . ,

$${M}_{symb}^{layer} - 1$$

shall be precoded according to

$$[ \begin{matrix}{z}^{( {p}_{0} )} ( i ) \\ ⋮ \\ {z}^{( {p}_{ρ - 1} )} ( i )\end{matrix} ] = W [ \begin{matrix}{y}^{( 0 )} ( i ) \\ ⋮ \\ {y}^{( υ - 1 )} ( i )\end{matrix} ]$$

where i=0.1 . . . ,

$${M}_{symb}^{ap} - 1 , {M}_{symb}^{ap} = {M}_{symb}^{layer} .$$

The set of antenna ports {p₀ . . . . P_{ρ-1}} shall be determined according to the procedure in 3GPP TS 38.214.

For non-codebook-based transmission, the precoding matrix W equals the identity matrix.

For codebook-based transmission, the precoding matrix W is given by W=1 for single-layer transmission on a single antenna port, otherwise by Tables 16 to 22 (taken from Tables 6.3.1.5-1 to 6.3.1.5-7 of 3GPP TS 38.211) with the TPMI index obtained from the DCI scheduling the uplink transmission or the higher layer parameters according to the procedure in 3GPP TS 38.214.

When the higher-layer parameter txConfig is not configured, the precoding matrix W=1.

TABLE 16
Precoding matrix W for single-layer transmission using two antenna ports.

| | W | | | | | | | |
|---|---|---|---|---|---|---|---|---|
| TPMI index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 17
Precoding matrix W for single-layer transmission using four antenna ports with
transform precoding enabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 18
Precoding matrix W for single-layer transmission using four antenna ports with
transform precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 19
Precoding matrix W for two-layer transmission using two antenna ports with transform
precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 20
Precoding matrix W for two-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 21
Precoding matrix W for three-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 22
Precoding matrix W for four-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4-6 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

For non-codebook based transmission, PUSCH can be scheduled by DCI format 0_0, DCI format 0_1, DCI format 0_2 or semi-statically configured to operate according to Clause 6.1.2.3 of 3GPP TS 38.214. If this PUSCH is scheduled by DCI format 0_1, DCI format 0_2, or semi-statically configured to operate according to Clause 6.1.2.3 of 3GPP TS 38.214, the UE can determine its PUSCH precoder and transmission rank based on the SRI when multiple SRS resources are configured, where the SRI is given by the SRS resource indicator in DCI according to clause 7.3.1.1.2 and 7.3.1.1.3 of 3GPP TS 38.212 for DCI format 0_1 and DCI format 0_2, or the SRI is given by srs-ResourceIndicator according to clause 6.1.2.3 of 3GPP TS 38.214.

The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListForDCI-Format0-2-r16 in SRS-config, respectively. The UE shall use one or multiple SRS resources for SRS transmission, where, in a SRS resource set, the maximum number of SRS resources which can be configured to the UE for simultaneous transmission in the same symbol and the maximum number of SRS resources are UE capabilities. The SRS resources transmitted simultaneously occupy the same RBs.

Only one SRS port for each SRS resource is configured. Only one SRS resource set can be configured with higher layer parameter usage in SRS-ResourceSet set to ‘nonCodebook’. The maximum number of SRS resources that can be configured for non-codebook based uplink transmission is 4. The indicated SRI in slot n is associated with the most recent transmission of SRS resource(s) identified by the SRI, where the SRS transmission is prior to the PDCCH carrying the SRI.

For non-codebook based transmission, the UE can calculate the precoder used for the transmission of SRS based on measurement of an associated NZP CSI-RS resource. A UE can be configured with only one NZP CSI-RS resource for the SRS resource set with higher layer parameter usage in SRS-ResourceSet set to ‘nonCodebook’ if configured.

The UE shall perform one-to-one mapping from the indicated SRI(s) to the indicated DM-RS ports(s) and their corresponding PUSCH layers {0 . . . v−1} given by DCI format 0_1 or by configuredGrantConfig according to clause 6.1.2.3 of 3GPP TS 38.214 in increasing order.

The UE shall transmit PUSCH using the same antenna ports as the SRS port(s) in the SRS resource(s) indicated by SRI(s) given by DCI format 0_1 or by configuredGrantConfig according to clause 6.1.2.3 of 3GPP TS 38.214, where the SRS port in (i+1)-th SRS resource in the SRS resource set is indexed as pᵢ=1000+i.

The DM-RS antenna ports {\tilde{p}₀, . . . , \tilde{p}_{υ-1}} in Clause 6.4.1.1.3 of 3GPP TS 38.211 are determined according to the ordering of DM-RS port(s) given by Tables 7.3.1.1.2-6 to 7.3.1.1.2-23 in Clause 7.3.1.1.2 of 3GPP TS 38.212.

For non-codebook based transmission, the UE does not expect to be configured with both spatialRelationInfo for SRS resource and associatedCSI-RS in SRS-ResourceSet for SRS resource set.

For non-codebook based transmission, the UE can be scheduled with DCI format 0_1 when at least one SRS resource is configured in SRS-ResourceSet with usage set to ‘nonCodebook’.

Regarding SRS configuration, as discussed in 3GPP TS 38.214, the UE may be configured with one or more SRS resource sets as configured by the higher layer parameter SRS-ResourceSet, wherein each SRS resource set is associated with K≥1 SRS resources (higher layer parameter SRS-Resource), where the maximum value of K is indicated by UE capability. The SRS resource set applicability is configured by the higher layer parameter usage in SRS-ResourceSet. The higher-layer parameter SRS-Resource configures some SRS parameters, including the SRS resource configuration identity (srs-ResourceId), the number of SRS ports (nrofSRS-Ports) with default value of one, and the time-domain behaviour of SRS resource configuration (resource Type).

The UE may be configured by the higher layer parameter resourceMapping in SRS-Resource with an SRS resource occupying Nₛ∈{1,2, 4} adjacent symbols within the last 6 symbols of the slot, where all antenna ports of the SRS resources are mapped to each symbol of the resource.

For a UE configured with one or more SRS resource configuration(s), and when the higher layer parameter resource Type in SRS-Resource is set to ‘aperiodic’:

The UE receives a configuration of SRS resource sets.

The UE receives a downlink DCI, a group common DCI, or an uplink DCI based command where a codepoint of the DCI may trigger one or more SRS resource set(s). For SRS in a resource set with usage set to ‘codebook’ or ‘antennaSwitching’, the minimal time interval between the last symbol of the PDCCH triggering the aperiodic SRS transmission and the first symbol of SRS resource is N₂. Otherwise, the minimal time interval between the last symbol of the PDCCH triggering the aperiodic SRS transmission and the first symbol of SRS resource is N₂+14. The minimal time interval in units of OFDM symbols is counted based on the minimum subcarrier spacing between the PDCCH and the aperiodic SRS.

If the UE is configured with the higher layer parameter spatialRelationInfo containing the ID of a reference ‘ssb-Index’, the UE shall transmit the target SRS resource with the same spatial domain transmission filter used for the reception of the reference SS/PBCH block, if the higher layer parameter spatialRelationInfo contains the ID of a reference ‘csi-RS-Index’, the UE shall transmit the target SRS resource with the same spatial domain transmission filter used for the reception of the reference periodic CSI-RS or of the reference semi-persistent CSI-RS, or of the latest reference aperiodic CSI-RS. If the higher layer parameter spatialRelationInfo contains the ID of a reference ‘srs’, the UE shall transmit the target SRS resource with the same spatial domain transmission filter used for the transmission of the reference periodic SRS or of the reference semi-persistent SRS or of the reference aperiodic SRS.

The update command contains spatial relation assumptions provided by a list of references to reference signal IDs, one per element of the updated SRS resource set. Each ID in the list refers to a reference SS/PBCH block, NZP CSI-RS resource configured on serving cell indicated by Resource Serving Cell ID field in the update command if present, same serving cell as the SRS resource set otherwise, or SRS resource configured on serving cell and uplink bandwidth part indicated by Resource Serving Cell ID field and Resource BWP ID field in the update command if present, same serving cell and bandwidth part as the SRS resource set otherwise.

When the UE is configured with the higher layer parameter usage in SRS-ResourceSet set to ‘antennaSwitching’, the UE shall not expect to be configured with different spatial relations for SRS resources in the same SRS resource set.

For PUCCH and SRS on the same carrier, a UE shall not transmit SRS when semi-persistent and periodic SRS are configured in the same symbol(s) with PUCCH carrying only CSI report(s), or only L1-RSRP report(s), or only L1-SINR report(s). A UE shall not transmit SRS when semi-persistent or periodic SRS is configured or aperiodic SRS is triggered to be transmitted in the same symbol(s) with PUCCH carrying HARQ-ACK, link recovery request (as defined in clause 9.2.4 of 3GPP TS 38.331 and 38.213) and/or SR. In the case that SRS is not transmitted due to overlap with PUCCH, only the SRS symbol(s) that overlap with PUCCH symbol(s) are dropped. PUCCH shall not be transmitted when aperiodic SRS is triggered to be transmitted to overlap in the same symbol with PUCCH carrying semi-persistent/periodic CSI report(s) or semi-persistent/periodic L1-RSRP report(s) only, or only L1-SINR report(s).

When the UE is configured with the higher layer parameter usage in SRS-ResourceSet set to ‘antennaSwitching’, and a guard period of Y symbols is configured according to Clause 6.2.1.2, the UE shall use the same priority rules as defined above during the guard period as if SRS was configured.

Regarding the UE sounding procedure, when the UE is configured with the higher-layer parameter usage in SRS-ResourceSet set as ‘antennaSwitching’, the UE may be configured with one configuration depending on the indicated UE capability supportedSRS-TxPortSwitch, which takes on the values {‘t1r2’, ‘t1r₁-t1r₂’, ‘t2r₄’, ‘t1r₄’, ‘t1r₁-t1r₂-t1r₄’, ‘t1r₄- t2r₄’, ‘t1r₁-t1r₂-t2r₂-t2r₄’, ‘t1r₁-t1r₂-t2r₂-t1r₄-t2r₄’, ‘t1r₁’, ‘t2r₂’, ‘t1r₁-t2r₂’, ‘t4r₄’, ‘t1r₁-t2r₂-t4r₄’}.

For 1T2R, up to two SRS resource sets configured with a different value for the higher layer parameter resource Type in SRS-ResourceSet set, where each set has two SRS resources transmitted in different symbols, each SRS resource in a given set consisting of a single SRS port, and the SRS port of the second resource in the set is associated with a different UE antenna port than the SRS port of the first resource in the same set, or

For 2T4R, up to two SRS resource sets configured with a different value for the higher layer parameter resourceType in SRS-Resource Set set, where each SRS resource set has two SRS resources transmitted in different symbols, each SRS resource in a given set consisting of two SRS ports, and the SRS port pair of the second resource is associated with a different UE antenna port pair than the SRS port pair of the first resource, or

For 1T4R, zero or one SRS resource set configured with higher layer parameter resource Type in SRS-ResourceSet set to ‘periodic’ or ‘semi-persistent’ with four SRS resources transmitted in different symbols, each SRS resource in a given set consisting of a single SRS port, and the SRS port of each resource is associated with a different UE antenna port, and

For 1T4R, zero or two SRS resource sets each configured with higher layer parameter resource Type in SRS-ResourceSet set to ‘aperiodic’ and with a total of four SRS resources transmitted in different symbols of two different slots, and where the SRS port of each SRS resource in the given two sets is associated with a different UE antenna port. The two sets are each configured with two SRS resources, or one set is configured with one SRS resource and the other set is configured with three SRS resources.

For 1T=1R, or 2T=2R, or 4T=4R, up to two SRS resource sets each with one SRS resource, where the number of SRS ports for each resource is equal to 1, 2, or 4.

The UE is configured with a guard period of Y symbols, in which the UE does not transmit any other signal, in the case the SRS resources of a set are transmitted in the same slot. The guard period is in-between the SRS resources of the set. The value of Y is 2 when the OFDM sub-carrier spacing is 120 kHz, otherwise Y=1.

For 1T2R, 1T4R or 2T4R, the UE shall not expect to be configured or triggered with more than one SRS resource set with higher layer parameter usage set as ‘antennaSwitching’ in the same slot. For 1T=1R, 2T=2R or 4T=4R, the UE shall not expect to be configured or triggered with more than one SRS resource set with higher layer parameter usage set as ‘antennaSwitching’ in the same symbol.

Regarding Antenna Panel/Port, Quasi-co-location (QCL), Transmission Configuration Indicator (TCI) state, and Spatial Relation, in some embodiments, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its transmit (Tx) beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi-co-located (QCL-ed) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial receive (Rx) parameters. Two antenna ports may be QCL-ed with respect to a subset of the large-scale properties and different subset of large-scale properties may be indicated by a QCL Type parameter.

The QCL Type parameter can indicate which channel properties are the same between the two reference signals (e.g., on the two antenna ports). Thus, the reference signals can be linked to each other with respect to what the UE can assume about their channel statistics or QCL properties. For example, parameter qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Spatial Rx parameters may include one or more of: angle of arrival (AoA), Dominant AoA, average AoA, angular spread, Power Angular Spectrum (PAS) of AoA, average angle of departure (AoD), PAS of AoD, transmit/receive channel correlation, transmit/receive beamforming, spatial channel correlation etc.

The values QCL-TypeA, QCL-TypeB, and QCL-TypeC may be applicable for all carrier frequencies, but the value QCL-TypeD may be applicable only in higher carrier frequencies (e.g., mmWave, FR2 and beyond), where essentially the UE may not be able to perform omni-directional transmission, i.e., the UE would need to form beams for directional transmission. A QCL-TypeD parameter between two reference signals A and B, the reference signal A is considered to be spatially co-located with reference signal B and the UE may assume that the reference signals A and B can be received with the same spatial filter (e.g., with the same Rx beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a Transmission Configuration Indication (TCI) state associated with a target transmission can indicate parameters for configuring a QCL relationship between the target transmission (e.g., target Reference Signal (RS) of Demodulation Reference Signal (DM-RS) ports of the target transmission during a transmission occasion) and a source reference signal(s) (e.g., Synchronization Signal Block (SSB), CSI-RS, and/or Sounding Reference Signal (SRS)) with respect to quasi co-location type parameter(s) indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In general, PUSCH transmission(s) can be dynamically scheduled by an UL grant in a DCI, or the transmission can correspond to a configured grant Type 1 or configured grant Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI according to Clause 10.2 of 3GPP TS 38.213 after the reception of higher layer parameter configuredGrantConfig not including rrc-ConfiguredUplinkGrant. If configuredGrantConfigToAddModList-r₁₆ is configured, more than one configured grant configuration of configured grant Type 1 and/or configured grant Type 2 may be active at the same time on an active BWP of a serving cell.

For the PUSCH transmission corresponding to a Type 1 configured grant or a Type 2 configured grant activated by DCI format 0_0 or 0_1, the parameters applied for the transmission are provided by configuredGrantConfig except for dataScramblingIdentityPUSCH, txConfig, codebookSubset, maxRank, scaling of UCI-OnPUSCH. which are provided by pusch-Config. For the PUSCH transmission corresponding to a Type 2 configured grant activated by DCI format 0_2, the parameters applied for the transmission are provided by configuredGrantConfig except for dataScramblingIdentityPUSCH, txConfig, codebookSubsetForDCI-Format0-2-r₁₆, maxRankForDCI-Format0-2-r₁₆, scaling of UCI-OnPUSCH, resource AllocationType1GranularityForDCI-Format0-2-r₁₆ provided by pusch-Config. 1f the UE is provided with transformPrecoder in configuredGrantConfig, the UE applies the higher layer parameter tp-pi2BPSK, if provided in pusch-Config, according to the procedure described in Clause 6.1.4 of 3GPP TS 38.214 for the PUSCH transmission corresponding to a configured grant.

For the PUSCH retransmission scheduled by a PDCCH with CRC scrambled by CS-RNTI with NDl=1, the parameters in pusch-Config are applied for the PUSCH transmission except for p0-NominalWithoutGrant, p0-PUSCH-Alpha, powerControlLoopToUse, pathlossReferenceIndex described in Clause 7.1 of 3GPP TS 38.213, mcs-Table, mcs-TableTransformPrecoder described in Clause 6.1.4.1 of 3GPP TS 38.214 and transformPrecoder described in Clause 6.1.3 of 3GPP TS 38.214.

For a UE configured with two uplinks in a serving cell, PUSCH retransmission for a TB on the serving cell is not expected to be on a different uplink than the uplink used for the PUSCH initial transmission of that TB.

A UE shall upon detection of a PDCCH with a configured DCI format 0_0, 0_1 or 0_2 transmit the corresponding PUSCH as indicated by that DCI. Upon detection of a DCI format 0_1 or 0_2 with “UL-SCH indicator” set to “0” and with a non-zero “CSI request” where the associated “reportQuantity” in CSI-ReportConfig set to “none” for all CSI report(s) triggered by “CSI request” in this DCI format 0_1 or 0_2, the UE ignores all fields in this DCI except the “CSI request” and the UE shall not transmit the corresponding PUSCH as indicated by this DCI format 0_1 or 0_2. When the UE is scheduled with multiple PUSCHs by a DCI, HARQ process ID indicated by this DCI applies to the first PUSCH, as described in clause 6.1.2.1, HARQ process ID is then incremented by 1 for each subsequent PUSCH(s) in the scheduled order, with modulo 16 operation applied. For any HARQ process ID(s) in a given scheduled cell, the UE is not expected to transmit a PUSCH that overlaps in time with another PUSCH. For any two HARQ process IDs in a given scheduled cell, if the UE is scheduled to start a first PUSCH transmission starting in symbol j by a PDCCH ending in symbol i, the UE is not expected to be scheduled to transmit a PUSCH starting earlier than the end of the first PUSCH by a PDCCH that ends later than symbol i. The UE is not expected to be scheduled to transmit another PUSCH by DCI format 0_0, 0_1 or 0_2 scrambled by C-RNTI or MCS-C-RNTI for a given HARQ process until after the end of the expected transmission of the last PUSCH for that HARQ process.

In general, the network would configure a UE with a Rel-18 UL codebook via a combination of one or more or the following indications represented in the list of implementations below. Note that according to a possible implementation, the occurrence of a combination of one or more implementations is also considered.

In a first implementation, a new value of the higher-layer parameter txConfig in PUSCH-Config IE is introduced. In a first example, the new value is ‘codebook-r18’.

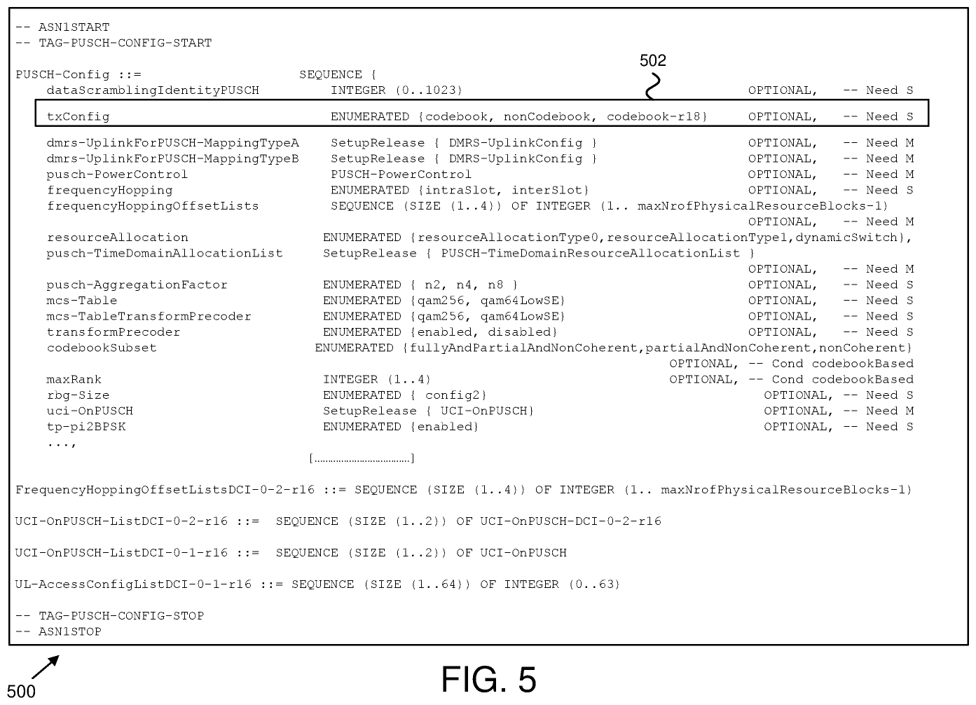

FIG. 5 depicts an example of the ASN.1 structure 500 that corresponds to the PUSCH Configuration IE comprising the higher-layer parameter txConfig 502, according to the first implementation. The original ASN.1 structure for this PUSCH-Config 1E can be found in Clause 6.3.2 of 3GPP TS 38.331. As depicted, the higher-layer parameter txConfig 502 may be extended to include the candidate enumerated value of ‘codebook-r18’.

In a second implementation, a new higher-layer parameter, e.g., ‘Codebook Type’ that indicates the codebook type, is introduced in PUSCH-Config 1E. In a first example, the new higher-layer parameter may take on one or more values e.g., ‘codebook-r₁₈’, ‘codebook-r₁₅’. In a second example, the new higher-layer parameter is configured if the higher-layer parameter txConfig in PUSCH-Config IE is configured with the value ‘codebook’.

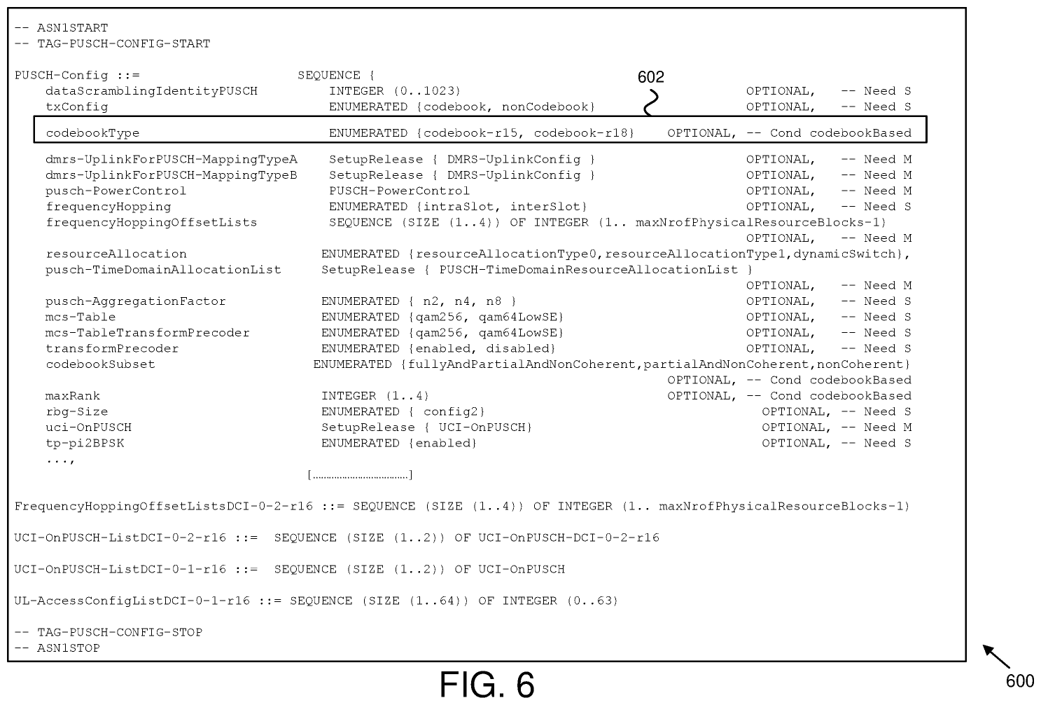

FIG. 6 depicts an example of the ASN.1 structure 600 that corresponds to the PUSCH Configuration IE comprising the higher-layer parameter rxConfig 502, according to the second implementation. The original ASN.1 structure for this PUSCH-Config 1E can be found in Clause 6.3.2 of 3GPP TS 38.331. As depicted, the PUSCH-Config IE may be extended to include a new higher-layer parameter codebookType 602, as described above.

In a third implementation, a Rel-18 UL codebook is inferred from the value of a “Precoding information and number of layers” field (e.g., one or more codepoints of the field) in a DCI scheduling PUSCH transmission, e.g., DCI Format 0_1 or DCI Format 0_2. This value indicates that a Rel-18 UL codebook is used for the PUSCH transmission and e.g., a TPMI is reported (e.g., signaled, or indicated, or provided) in a following DCI that is transmitted, e.g., over PDCCH, or PDSCH or indicated in a MAC-CE (Control Element) on PDSCH. In one example, the value of a “Precoding information and number of layers” field in the DCI scheduling PUSCH transmission indicates that the TPMI follows the most recent indicated TPMI(s) (e.g., sub-band TPMIs) to the UE. The most recent indicated TPMI may be indicated in a DCI that is transmitted, e.g., over PDCCH, or PDSCH or indicated in a MAC-CE (Control Element) on PDSCH.

In a fourth implementation, a Rel-18 UL codebook is inferred from the value of a higher-layer parameter usage for an SRS-resourceSet. In one example, the parameter usage set to ‘codebook-r₁₈’. In other words, the codebook type (i.e., Rel-18 UL codebook) may be inferred from the SRS resource set.

In a fifth implementation, a Rel-18 UL codebook is inferred from the association of the codebook configuration with an SRS resource, wherein the SRS resource comprises 8 SRS ports. In other words, the codebook type (i.e., Rel-18 UL codebook) may be inferred from the number of SRS ports of the SRS resource.

A UE associated with codebook-based precoding of PUSCH layers may need to signal a set of parameters corresponding to the UE antenna configuration to the network, based on the UE capability and/or hardware setup. In other words, the UE may signal the antenna configuration parameters to a RAN entity (e.g., gNB). Several implementations that describe some aspects related to the antenna configuration are described below. According to a possible implementation, one or more elements or features from one or more of the described implementations may be combined.

In a first implementation, a parameter of the set of parameters comprises a total number of antenna ports. In other words, said parameter may be used to signal the number of SRS ports.

In a first example, an antenna port corresponds to an SRS port of at least one SRS resource, wherein each SRS resource of the at least one SRS resource is associated with an SRS resource set. In a second example, the total number of antenna ports is inferred from a maximum number of SRS resources per set. In a third example, the total number of antenna ports is inferred from a maximum number of simultaneous transmitted SRS resources at one symbol.

In a second implementation, a parameter of the set of parameters comprises a decomposition of the SRS ports to two indicators, a first indicator corresponds to a number of ports in a first dimension, e.g., N₁, and a second indicator corresponds to a number of ports in a second dimension, e.g., N₂. In other words, said parameter may be used to signal the number of horizontal antennas (N₁) and/or the number of vertical antennas (N₂).

In a first example, the first dimension is a horizontal dimension, and the second dimension is a vertical dimension. In a second example, a product of the number of ports in the first dimension, and the number of ports in the second dimension corresponds to the total number of ports in at least one polarization.

In a third implementation, a parameter of the set of parameters corresponds to a number of antenna groups, wherein antenna ports corresponding to each antenna group share a same set of antenna characteristics. In other words, said parameter may be used to signal the number of antenna groups.

In a first example, the number of antenna ports in each antenna group of the antenna groups is the same. In a second example, the of antenna ports in each antenna group are fully coherent. In a third example, the antenna ports in each antenna group are associated with a same SRS resource of the at least one SRS resource. In a fourth example, antenna ports in each coherence group are associated with a same SRS resource set.

In a fifth example, antennas corresponding to a same antenna group are associated with a uniform spacing in at least one dimension. In a sixth example, antennas corresponding to a same antenna group are associated with a same QCL relationship at least with respect to a spatial relation information. In a seventh example, two antennas corresponding to different antenna groups are associated with a different QCL relationship at least with respect to a spatial relation information.

In a fourth implementation, a parameter of the set of parameters corresponds to a number of antenna ports in each antenna group. In other words, said parameter may be used to signal the antenna group size.

In a fifth implementation, a parameter of the set of parameters corresponds to a number of coherence groups, wherein two antenna ports associated with to a same coherence correspond to a first coherence type, and two antenna ports associated with different coherence groups correspond to a second coherence type. In other words, said parameter may be used to signal the number of coherence groups.

In a first example, the number of antenna ports in each coherence group of the coherence groups is the same. In a second example, the first coherence type is a full coherence, and the second coherence type is a partial coherence. In a third example, the first coherence type is a full coherence, and the second coherence type is a non-coherence.

In a fourth example, the first coherence type is a partial coherence, and the second coherence type is a non-coherence. In a fifth example, antenna ports in each coherence group are associated with a same SRS resource of the at least one SRS resource. In a sixth example, antenna ports in each coherence group are associated with a same SRS resource set.

In a sixth implementation, a parameter of the set of parameters corresponds to a number of antenna ports in each coherence group. Accordingly, said parameter may be used to signal the coherence group size.

In a seventh implementation, the number of coherence groups is less than or equal to the number of antenna groups. Accordingly, there may be a relationship between the antenna groups and the coherence groups, in accordance with the present disclosure. In a first example, the number of antenna groups is an integer multiple of the number of coherence groups, e.g., 4 and 2, respectively. In a second example, each antenna group of the antenna groups is associated with a coherence group.

In a third example, coherence groups are identical to antenna groups, and the number of coherence groups is equal to the number of antenna groups. In a fourth example, the number of coherence groups is one, and antennas of all antenna groups are associated with a same coherence type. In a fifth example, a parameter of the set of parameters corresponds to a mapping of the antennas of an antenna group to a coherence group.

In an eighth implementation, a UE is configured with at least one of the following antenna coherence modes: a fully-coherent mode, a non-coherent mode, and a partially coherent mode, wherein the partially coherent mode is further categorized into a plurality of coherence sub-modes based on a number of antenna ports, a number of antenna groups, a number of coherence groups, or a combination thereof. In other words, the coherence modes supported may be based on the legacy modes.

In a first example, for a UE equipped with a total of 8 antenna ports, a first coherence sub-mode of the plurality of coherence sub-modes corresponds to a total number of two coherence groups, and a second coherence sub-mode of the plurality of coherence sub-modes corresponds to a total number of four coherence groups. In a second example, a UE whose total number of antenna ports is equal to the number of coherence groups, is configured with a non-coherent mode. In a third example, a UE whose number of coherence groups is one is configured with a fully coherent mode.

In a ninth implementation, the set of parameters are signaled as part of Layer-1 UE features signaling. In a first example, the Layer-1 UE features signaling is associated with codebook based PUSCH MIMO transmission. In a second example, the Layer-1 UE features signaling follows that of Clause 4.1 in is based on Clause 4.1 in 3GPP TR 38.822.

A UE configured with PUSCH transmission via codebook-based precoding is also configured with a codebook type, wherein the codebook type is based on a value of at least one parameter of a set of parameters associated with the antenna configuration at the UE. In other words, the codebook structure may be based on the antenna configuration. Several implementations that describe different codebook structures and their relationship with a given antenna configuration are described below. According to a possible implementation, one or more elements or features from one or more of the described implementations may be combined.

In a first implementation, the UE is associated with a selected codebook type of a set of codebook types, wherein the selected codebook type is configured as part of the PUSCH configuration. For example, the codebook type may be configured by RRC signaling.

In a second implementation, the set of codebook types comprises an antenna selection codebook type, wherein an antenna port is selected for a precoding vector corresponding to a PUSCH layer. In one example, for an antenna selection codebook type, a different antenna port is selected for PUSCH layer of a set of PUSCH layers.

In a third implementation, the set of codebook types comprises a codebook type that is based on a Rel-15 UL codebook with a transform precoding disabled. In other words, the Rel-15 codebook may be extended to indicate a TPMI codebook type.

In one example, a precoding matrix W corresponding to 8 antenna ports is in a form of an augmentation of two precoding matrices W₁ and W₂, wherein each of W₁ and W₂ correspond to a precoding matrix using four antenna ports with a transform precoding disabled, as shown in Table 23, Table 24, Table 25 and Table 26, such that

$$W = [ \begin{matrix}{W}_{1} & {0}_{1} \\ {0}_{2} & {W}_{2}\end{matrix} ]$$

For instance, W is a precoding matrix for five-layer transmission using 8 antenna ports, whose matrix size is 8×5, W₁ is a Rel-15 precoding matrix for three-layer transmission using 4 antenna ports with transform precoding disabled, based on one of the precoding matrices in Table 26, whose matrix size is a 4×3 corresponding to a first 4 UE antenna ports of the 8 UE antenna ports of W and a first 3 layers of the 5 layers of W, W₂ is a Rel-15 precoding matrix for two-layer transmission using 4 antenna ports with transform precoding disabled, based on one of the precoding matrices in Table 25, whose matrix size is a 4×2 corresponding to a last 4 UE antenna ports of the 8 UE antenna ports of W and a last 2 layers of the 5 layers of W, and 0₁, 0₂ are all-zero matrices of dimensions 4×2 and 4×3, respectively.

TABLE 23
Precoding matrix W for single-layer transmission using four antenna ports with transform
precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 24
Precoding matrix W for four-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

TABLE 25
Precoding matrix W for two-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 26
Precoding matrix W for three-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

In a fourth implementation, the set of codebook types comprises a DFT-based codebook type. In a first example, the DFT-based codebook type using eight antenna ports is based on Rel-15 DL Type-I codebook, wherein a spatial transformation matrix is a block-diagonal matrix with two identical diagonal blocks corresponding to a DFT matrix, as follows

$${W}_{1} = [ \begin{matrix}B & 0 \\ 0 & B\end{matrix} ]$$

where the matrix B is a matrix whose columns are selected from a DFT matrix of size 4×4.

In a second example, the DFT-based codebook type using eight antenna ports is based on Rel-15 DL Type-I codebook, wherein a spatial transformation matrix is based on a matrix B, i.e., W₁=B wherein the columns of B are selected from a DFT matrix of size 8×8

In a third example, the matrix B is an N₁N₂×L matrix with L≤N₁N₂ columns drawn from a 2D oversampled DFT matrix, as follows

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} , B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , {l}_{i} = {O}_{1} {n}_{1}^{( i )} + {q}_{1} , 0 \leq {n}_{1}^{( i )} < {N}_{1} , 0 \leq {q}_{1} < {O}_{1} - 1 , {m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

In a fourth example, the matrix B is an N×L matrix with L≤N columns drawn from an oversampled DFT matrix, as follows

$${u}_{m} = [ \begin{matrix}1 & {e}^{j \frac{2 π m}{ON}} & … & {e}^{j \frac{2 π m ( N - 1 )}{ON}}\end{matrix} ] , B = [ \begin{matrix}{u}_{{m}_{0}} & {u}_{{m}_{1}} & … & {u}_{{m}_{L - 1}}\end{matrix} ] , {m}_{i} = {On}^{( i )} + q , 0 \leq {n}^{( i )} < N , 0 \leq q < O - 1$$

In a fifth implementation, the UE is associated with a selected codebook type of a set of codebook types, wherein the selected codebook type is set by a rule based on at least one of an antenna configuration, a number of antenna ports, a number of SRS resource sets associated with the TPMI, a number of SRS resources associated with the TPMI, a number of TPMI, a number of antenna groups, a number of coherence groups, or a combination thereof. In other words, according to the fifth implementation, the codebook type selection is based on a rule associated with the antenna configuration values.

In a first example, an antenna configuration with 8 antenna ports and a plurality of antenna groups, wherein a number of antenna ports in each antenna group is two, corresponds to a Rel-15 UL based codebook type with a transform precoding disabled.

In a second example, an antenna configuration with 8 antenna ports and at least one antenna group, wherein a number of antenna ports in each antenna group is no less than four, corresponds to a DFT-based codebook type.

In a third example, an antenna configuration with 8 antenna ports, one coherence group and no more than two antenna groups, corresponds to a DFT-based codebook type.

In a fourth example, an antenna configuration with 8 antenna ports, more than two coherence groups, corresponds to a Rel-15 UL based codebook type with a transform precoding disabled.

In a fifth example, an antenna configuration with 8 antenna ports and 8 coherence groups, corresponds to an antenna selection based codebook type.

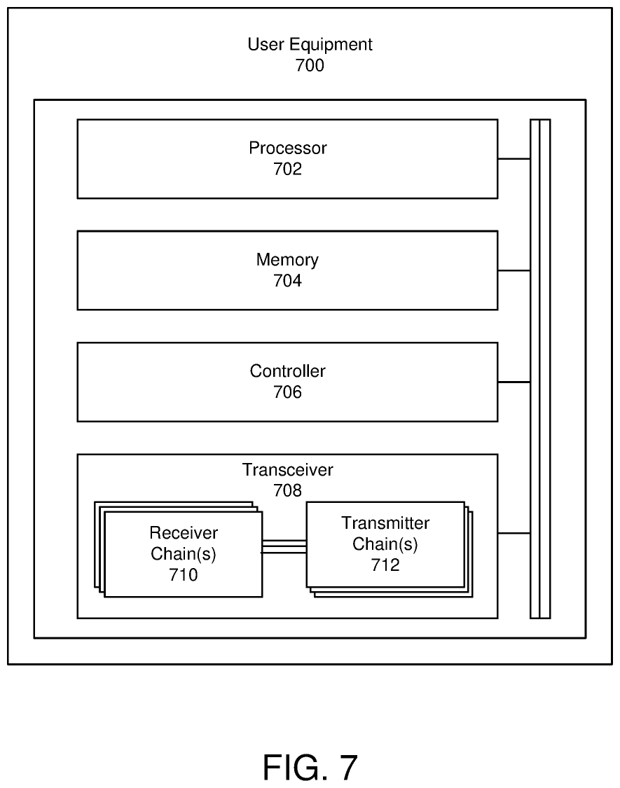

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, a Field Programmable Gate Array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to support a means for transmitting a set of parameters corresponding to an antenna configuration of the UE 700. In such implementations, the antenna configuration includes information on an antenna grouping of the UE 700, or a coherence grouping across antenna ports of the UE 700, or both.

In some embodiments, the set of parameters corresponding to the antenna configuration includes a total number of SRS ports over the set of SRSs. In some embodiments, the set of SRSs correspond to at least one SRS resource, where each SRS resource of the at least one SRS resource is associated with an SRS resource set.

In some embodiments, the set of parameters corresponding to the antenna configuration comprises a decomposition of the SRS ports to two indicators. In such embodiments, a first indicator may correspond to a total number of SRS ports in a first dimension (e.g., horizontal), and a second indicator may correspond to a total number of SRS ports in a second dimension (e.g., vertical).

In some embodiments, the set of parameters corresponding to the antenna configuration comprises a number of antenna groups. In such embodiments, antenna ports corresponding to each antenna group share a same set of antenna characteristics.

In certain embodiments, the antenna groups are characterized with at least one of: A) a number of antenna ports in each antenna group of the antenna groups is the same: B) antenna ports in each antenna group are fully coherent; C) antenna ports in each antenna group are associated with a same SRS resource of the at least one SRS resource: D) antenna ports in each coherence group are associated with a same SRS resource set: E) antennas corresponding to a same antenna group are associated with a uniform spacing in at least one dimension: F) antennas corresponding to a same antenna group are associated with a same QCL relationship at least with respect to a spatial relation information: or G) a combination thereof.

In some embodiments, the set of parameters corresponding to the antenna configuration includes a number of coherence groups. In such embodiments, two antenna ports associated with a same coherence may correspond to a first coherence type, and two antenna ports associated with different coherence groups may correspond to a second coherence type.

In certain embodiments, the coherence groups are characterized with at least one of: A) a number of antenna ports in each coherence group of the coherence groups is the same: B) the first coherence type is a full coherence, and the second coherence type is a partial coherence: C) the first coherence type is a full coherence, and the second coherence type is a non-coherence: D) the first coherence type is a partial coherence, and the second coherence type is a non-coherence; E) antenna ports in each coherence group are associated with a same SRS resource of the at least one SRS resource: F) antenna ports in each coherence group are associated with a same SRS resource set: or G) a combination thereof.

In certain embodiments, the number of coherence groups is less than or equal to a number of antenna groups. In one embodiment, coherence groups are identical to antenna groups, and the number of coherence groups is equal to the number of antenna groups.

The UE 700 may be configured to support a means for receiving a codebook configuration from a RAN corresponding to an UL codebook-based transmission, e.g., over a PUSCH. In some implementations, the codebook configuration corresponding to the UL codebook-based transmission is indicated via at least one of: A) a transmission configuration within a PUSCH configuration: B) a codebook type based on a codebook-based transmission configuration: C) a usage parameter of a configuration of an SRS resource set corresponding to the codebook-based transmission: or D) a combination thereof.

The UE 700 may be configured to support a means for transmitting a set of SRSs over the antenna ports based on the antenna configuration and a means for receiving at least one TPMI corresponding to a codebook-based transmission, e.g., over the PUSCH.

In some embodiments, the UE 700 is configured with at least one of the following antenna coherence modes: a fully-coherent mode, a non-coherent mode, and a partially coherent mode. In certain embodiments, the partially coherent mode is further categorized into a plurality of coherence sub-modes based on a number of antenna ports, a number of antenna groups, a number of coherence group, or a combination thereof.

In some embodiments, the set of parameters corresponds to Layer-1 UE features signaling. In certain embodiments, the Layer-1 UE features signaling is associated with codebook based PUSCH MIMO transmission.

In some embodiments, the UE 700 is associated with a selected codebook type of a set of codebook types. In certain embodiments, the set of codebook types comprises an antenna selection codebook type, wherein an antenna port is selected for a precoding vector corresponding to a PUSCH layer.

In some embodiments, the set of codebook types comprises a codebook type that is based on a Rel-15 UL codebook with a transform precoding disabled. In certain embodiments, a precoding matrix corresponding to a number of antenna ports is an augmentation of two precoding sub-matrices, each precoding sub-matrix is based on a precoding matrix corresponding to a half of the number of antenna ports.

In certain embodiments, the set of codebook types comprises a codebook type that is based on a DFT-based codebook type, wherein columns of the precoding matrix corresponds to a subset of columns of a DFT matrix.

In certain embodiments, the selected codebook type is set by a rule based on at least one of an antenna configuration, a number of antenna ports, a number of SRS resource sets associated with the TPMI, a number of SRS resources associated with the TPMI, a number of TPMI, a number of antenna groups, a number of coherence groups, or a combination thereof.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS® or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the receiving signal and obtain the transmitted data by reversing the modulation technique applied during transmission of the signal. The receiver chain 710 may include at least one decoder for decoding and processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

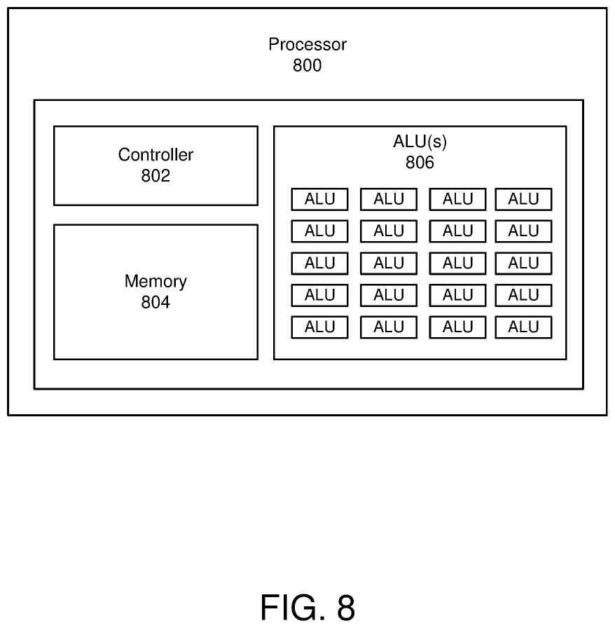

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support a means for transmitting a set of parameters corresponding to an antenna configuration of a UE. In such implementations, the antenna configuration includes information on an antenna grouping of the UE, or a coherence grouping across antenna ports of the UE, or both.

In some embodiments, the set of parameters corresponding to the antenna configuration includes a total number of SRS ports over the set of SRSs. In some embodiments, the set of SRSs correspond to at least one SRS resource, where each SRS resource of the at least one SRS resource is associated with an SRS resource set.

In some embodiments, the set of parameters corresponding to the antenna configuration comprises a decomposition of the SRS ports to two indicators. In such embodiments, a first indicator may correspond to a total number of SRS ports in a first dimension (e.g., horizontal), and a second indicator may correspond to a total number of SRS ports in a second dimension (e.g., vertical).

In some embodiments, the set of parameters corresponding to the antenna configuration comprises a number of antenna groups. In such embodiments, antenna ports corresponding to each antenna group share a same set of antenna characteristics.

In certain embodiments, the antenna groups are characterized with at least one of: A) a number of antenna ports in each antenna group of the antenna groups is the same: B) antenna ports in each antenna group are fully coherent; C) antenna ports in each antenna group are associated with a same SRS resource of the at least one SRS resource: D) antenna ports in each coherence group are associated with a same SRS resource set: E) antennas corresponding to a same antenna group are associated with a uniform spacing in at least one dimension: F) antennas corresponding to a same antenna group are associated with a same QCL relationship at least with respect to a spatial relation information: or G) a combination thereof.

In some embodiments, the set of parameters corresponding to the antenna configuration includes a number of coherence groups. In such embodiments, two antenna ports associated with a same coherence may correspond to a first coherence type, and two antenna ports associated with different coherence groups may correspond to a second coherence type.

In certain embodiments, the coherence groups are characterized with at least one of: A) a number of antenna ports in each coherence group of the coherence groups is the same: B) the first coherence type is a full coherence, and the second coherence type is a partial coherence: C) the first coherence type is a full coherence, and the second coherence type is a non-coherence: D) the first coherence type is a partial coherence, and the second coherence type is a non-coherence; E) antenna ports in each coherence group are associated with a same SRS resource of the at least one SRS resource: F) antenna ports in each coherence group are associated with a same SRS resource set: or G) a combination thereof.

In certain embodiments, the number of coherence groups is less than or equal to a number of antenna groups. In one embodiment, coherence groups are identical to antenna groups, and the number of coherence groups is equal to the number of antenna groups.

The processor 800 may be configured to support a means for receiving a codebook configuration from a RAN corresponding to an UL codebook-based transmission, e.g., over a PUSCH. In some implementations, The method of claim 1 wherein the codebook configuration corresponding to the UL codebook-based transmission is indicated via at least one of: A) a transmission configuration within a PUSCH configuration: B) a codebook type based on a codebook-based transmission configuration: C) a usage parameter of a configuration of an SRS resource set corresponding to the codebook-based transmission: or D) a combination thereof.

The processor 800 may be configured to support a means for transmitting a set of SRSs over the antenna ports based on the antenna configuration and a means for receiving at least one TPMI corresponding to a codebook-based transmission, e.g., over the PUSCH.

In some embodiments, the processor 800 is configured with at least one of the following antenna coherence modes: a fully-coherent mode, a non-coherent mode, and a partially coherent mode. In certain embodiments, the partially coherent mode is further categorized into a plurality of coherence sub-modes based on a number of antenna ports, a number of antenna groups, a number of coherence group, or a combination thereof.

In some embodiments, the set of parameters corresponds to Layer-1 UE features signaling. In certain embodiments, the Layer-1 UE features signaling is associated with codebook based PUSCH MIMO transmission.

In some embodiments, the processor 800 is associated with a selected codebook type of a set of codebook types. In certain embodiments, the set of codebook types comprises an antenna selection codebook type, wherein an antenna port is selected for a precoding vector corresponding to a PUSCH layer.

In some embodiments, the set of codebook types comprises a codebook type that is based on a Rel-15 UL codebook with a transform precoding disabled. In certain embodiments, a precoding matrix corresponding to a number of antenna ports is an augmentation of two precoding sub-matrices, each precoding sub-matrix is based on a precoding matrix corresponding to a half of the number of antenna ports.

In certain embodiments, the set of codebook types comprises a codebook type that is based on a DFT-based codebook type, wherein columns of the precoding matrix corresponds to a subset of columns of a DFT matrix.

In certain embodiments, the selected codebook type is set by a rule based on at least one of an antenna configuration, a number of antenna ports, a number of SRS resource sets associated with the TPMI, a number of SRS resources associated with the TPMI, a number of TPMI, a number of antenna groups, a number of coherence groups, or a combination thereof.

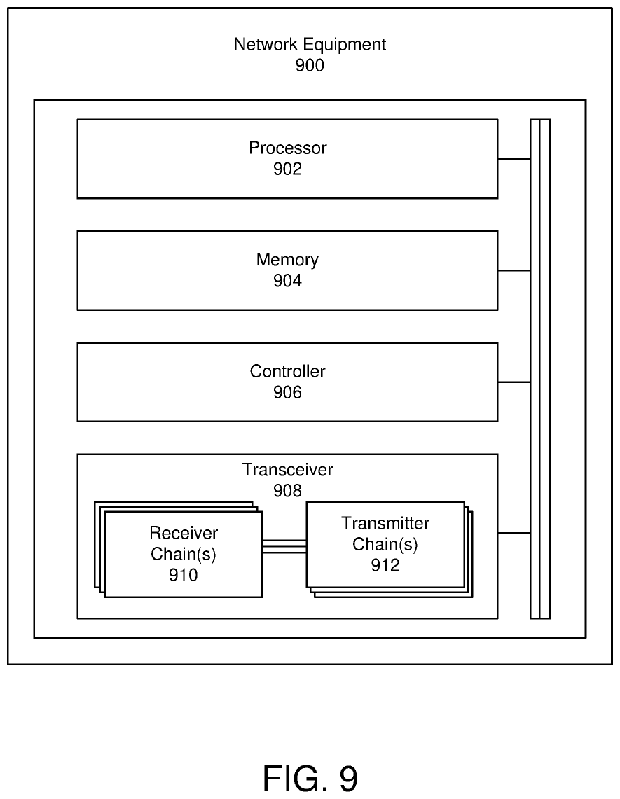

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to support a means for receiving, from a UE, a set of parameters corresponding to an antenna configuration of the UE, wherein the antenna configuration comprises information on at least one of an antenna grouping of the UE, or a coherence grouping across antenna ports of the UE, or both.

In some embodiments, the set of parameters corresponding to the antenna configuration includes a total number of SRS ports over the set of SRSs. In some embodiments, the set of SRSs correspond to at least one SRS resource, where each SRS resource of the at least one SRS resource is associated with an SRS resource set.

In some embodiments, the set of parameters corresponding to the antenna configuration comprises a decomposition of the SRS ports to two indicators. In such embodiments, a first indicator may correspond to a total number of SRS ports in a first dimension (e.g., horizontal), and a second indicator may correspond to a total number of SRS ports in a second dimension (e.g., vertical).

In some embodiments, the set of parameters corresponding to the antenna configuration comprises a number of antenna groups. In such embodiments, antenna ports corresponding to each antenna group share a same set of antenna characteristics.

In certain embodiments, the antenna groups are characterized with at least one of: A) a number of antenna ports in each antenna group of the antenna groups is the same: B) antenna ports in each antenna group are fully coherent; C) antenna ports in each antenna group are associated with a same SRS resource of the at least one SRS resource: D) antenna ports in each coherence group are associated with a same SRS resource set: E) antennas corresponding to a same antenna group are associated with a uniform spacing in at least one dimension: F) antennas corresponding to a same antenna group are associated with a same QCL relationship at least with respect to a spatial relation information: or G) a combination thereof.

In some embodiments, the set of parameters corresponding to the antenna configuration includes a number of coherence groups. In such embodiments, two antenna ports associated with a same coherence may correspond to a first coherence type, and two antenna ports associated with different coherence groups may correspond to a second coherence type.

In certain embodiments, the coherence groups are characterized with at least one of: A) a number of antenna ports in each coherence group of the coherence groups is the same: B) the first coherence type is a full coherence, and the second coherence type is a partial coherence: C) the first coherence type is a full coherence, and the second coherence type is a non-coherence: D) the first coherence type is a partial coherence, and the second coherence type is a non-coherence; E) antenna ports in each coherence group are associated with a same SRS resource of the at least one SRS resource: F) antenna ports in each coherence group are associated with a same SRS resource set: or G) a combination thereof.

In certain embodiments, the number of coherence groups is less than or equal to a number of antenna groups. In one embodiment, coherence groups are identical to antenna groups, and the number of coherence groups is equal to the number of antenna groups.

The NE 900 may be configured to support a means for transmitting a codebook configuration corresponding to an UL codebook-based transmission, e.g., over a PUSCH. In some implementations, The method of Claim 1 wherein the codebook configuration corresponding to the UL codebook-based transmission is indicated via at least one of: A) a transmission configuration within a PUSCH configuration: B) a codebook type based on a codebook-based transmission configuration: C) a usage parameter of a configuration of an SRS resource set corresponding to the codebook-based transmission: or D) a combination thereof.

The NE 900 may be configured to support a means for receiving a set of SRSs over the antenna ports based on the antenna configuration and a means for transmitting at least one TPMI corresponding to a codebook-based transmission, e.g., over the PUSCH.

In some embodiments, the UE is configured with at least one of the following antenna coherence modes: a fully-coherent mode, a non-coherent mode, and a partially coherent mode. In certain embodiments, the partially coherent mode is further categorized into a plurality of coherence sub-modes based on a number of antenna ports, a number of antenna groups, a number of coherence group, or a combination thereof.

In some embodiments, the set of parameters corresponds to Layer-1 UE features signaling. In certain embodiments, the Layer-1 UE features signaling is associated with codebook based PUSCH MIMO transmission.

In some embodiments, the UE is associated with a selected codebook type of a set of codebook types. In certain embodiments, the set of codebook types comprises an antenna selection codebook type, wherein an antenna port is selected for a precoding vector corresponding to a PUSCH layer.

In some embodiments, the set of codebook types comprises a codebook type that is based on a Rel-15 UL codebook with a transform precoding disabled. In certain embodiments, a precoding matrix corresponding to a number of antenna ports is an augmentation of two precoding sub-matrices, each precoding sub-matrix is based on a precoding matrix corresponding to a half of the number of antenna ports.

In certain embodiments, the set of codebook types comprises a codebook type that is based on a DFT-based codebook type, wherein columns of the precoding matrix corresponds to a subset of columns of a DFT matrix.

In certain embodiments, the selected codebook type is set by a rule based on at least one of an antenna configuration, a number of antenna ports, a number of SRS resource sets associated with the TPMI, a number of SRS resources associated with the TPMI, a number of TPMI, a number of antenna groups, a number of coherence groups, or a combination thereof.

The controller 906 may manage input and output signals for the NE 900. The controller 906 may also manage peripherals not integrated into the NE 900. In some implementations, the controller 906 may utilize an operating system (OS) such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the receiving signal and obtain the transmitted data by reversing the modulation technique applied during transmission of the signal. The receiver chain 910 may include at least one decoder for decoding and processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

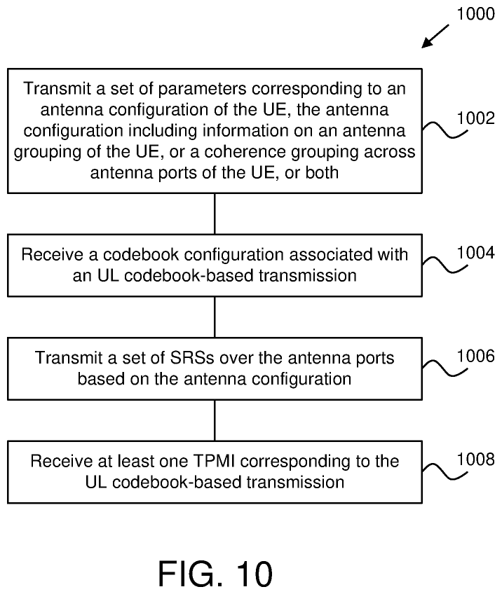

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At Step 1002, the method 1000 may include transmitting a set of parameters corresponding to an antenna configuration of the UE, where the antenna configuration comprises information on at least one of an antenna grouping of the UE, or a coherence grouping across antenna ports of the UE, or both. The operations of Step 1002 may be performed in accordance with examples as described herein. In some implementations, aspects of the operations of Step 1002 may be performed by a UE as described with reference to FIG. 7.

At Step 1004, the method 1000 may include receiving a codebook configuration associated with an UL codebook-based transmission. The operations of Step 1004 may be performed in accordance with examples as described herein. In some implementations, aspects of the operations of Step 1004 may be performed by a UE as described with reference to FIG. 7.

At Step 1006, the method 1000 may include transmitting a set of SRSs over the antenna ports based on the antenna configuration. The operations of Step 1006 may be performed in accordance with examples as described herein. In some implementations, aspects of the operations of Step 1006 may be performed a UE as described with reference to FIG. 7.

At Step 1008, the method 1000 may include receiving at least one TPMI corresponding to the UL codebook-based transmission. The operations of Step 1008 may be performed in accordance with examples as described herein. In some implementations, aspects of the operations of Step 1008 may be performed a UE as described with reference to FIG. 7.

It should be noted that the method 1000 described herein describes one possible implementation, and that the operations and the steps may be rearranged or otherwise modified and that other implementations are possible.

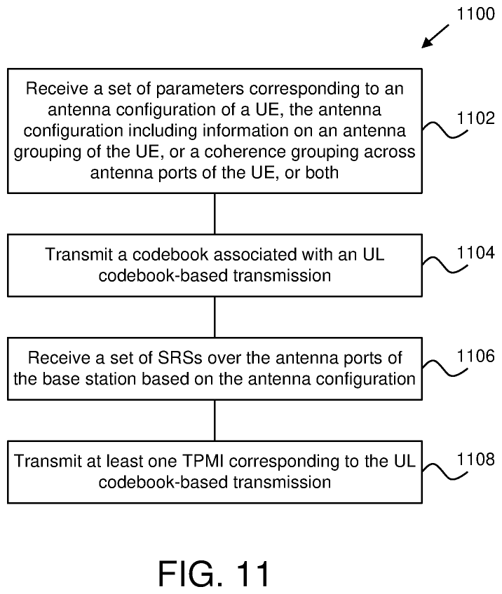

FIG. 11 illustrates a flowchart of a method 1100 in accordance with aspects of the present disclosure. The operations of the method 1100 may be implemented by a NE as described herein. In some implementations, the NE may execute a set of instructions to control the function elements of the NE to perform the described functions.

At Step 1102, the method 1100 may include receiving a set of parameters corresponding to an antenna configuration of the UE, where the antenna configuration comprises information on at least one of an antenna grouping of the UE, or a coherence grouping across antenna ports of the UE, or both. The operations of Step 1102 may be performed in accordance with examples as described herein. In some implementations, aspects of the operations of Step 1102 may be performed by a NE as described with reference to FIG. 9.

At Step 1104, the method 1100 may include transmitting a codebook configuration associated with an UL codebook-based transmission. The operations of Step 1104 may be performed in accordance with examples as described herein. In some implementations, aspects of the operations of Step 1104 may be performed by a NE as described with reference to FIG. 9.

At Step 1106, the method 1100 may include receiving a set of SRSs over the antenna ports based on the antenna configuration. The operations of Step 1106 may be performed in accordance with examples as described herein. In some implementations, aspects of the operations of Step 1106 may be performed a NE as described with reference to FIG. 9.

At Step 1108, the method 1100 may include transmitting at least one TPMI corresponding to the UL codebook-based transmission. The operations of Step 1108 may be performed in accordance with examples as described herein. In some implementations, aspects of the operations of Step 1108 may be performed a NE as described with reference to FIG. 9.

It should be noted that the method 1100 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
transmit a set of parameters corresponding to an antenna configuration of the UE, wherein the antenna configuration comprises information on an antenna grouping or a coherence grouping across antenna ports of the UE;
transmit a set of sounding reference signals (SRSs) over the antenna ports based on the antenna configuration; and
receive at least one transmit precoding matrix indicator (TPMI) based on the set of SRSs, the TPMI corresponding to an uplink (UL) codebook-based transmission.

2. The UE of claim 1, wherein the at least one processor is configured to cause the UE to receive a codebook configuration associated with an uplink (UL) codebook-based transmission, and wherein the codebook configuration is indicated via one or more of:
a transmission configuration within included in a physical uplink shared channel (PUSCH) configuration;
a codebook type based on a codebook-based transmission configuration;
a usage parameter of a configuration of an SRS resource set corresponding to the UL codebook-based transmission; or
a combination thereof.

3. The UE of claim 1, wherein the set of parameters comprises an indicator of a total number of SRS ports associated with the set of SRSs, or a group of indicators of a quantity of SRS ports over associated with a plurality of spatial dimensions, wherein the set of SRSs corresponds to at least one SRS resource, wherein each SRS resource of the at least one SRS resource is associated with an SRS resource set.

4. The UE of claim 1, wherein the set of parameters comprises a quantity of antenna groups, wherein a grouping of antenna ports corresponding to each antenna group shares a same set of antenna characteristics.

5. The UE of claim 4, wherein the antenna groups have one or more of the following characteristics:
a quantity of antenna ports in each antenna group of the quantity of antenna groups is the same;
one or more antenna ports in each antenna group are fully coherent;
one or more antenna ports in each antenna group are associated with a same SRS resource of the at least one SRS resource;
one or more antenna ports in each antenna group are associated with a same SRS resource set;
a set of antennas corresponding to a same antenna group are associated with a uniform spacing in at least one dimension;
the set of antennas corresponding to a respective antenna group are associated with a same QCL relationship with respect to at least a spatial relation information; or
a combination thereof.

6. The UE of claim 1, wherein the set of parameters comprises a quantity of coherence groups, wherein two antenna ports associated with a same coherence correspond to a first coherence type, and wherein two antenna ports associated with different coherence groups correspond to a second coherence type.

7. The UE of claim 6, wherein the coherence groups are characterized with one or more of:
a quantity of antenna ports in each coherence group of the coherence groups is the same;
the first coherence type is a full coherence, and the second coherence type is a partial coherence;
the first coherence type is the full coherence, and the second coherence type is a non-coherence;
the first coherence type is the partial coherence, and the second coherence type is the non-coherence;
one or more antenna ports in each coherence group are associated with a same SRS resource of the at least one SRS resource;
one or more antenna ports in each coherence group are associated with a same SRS resource set; or
a combination thereof.

8. The UE of claim 7, wherein each coherence group corresponds to one or more antenna groups, and wherein each antenna group is associated with no more than one coherence group.

9. The UE of claim 8, wherein a quantity of coherence groups is equal to the quantity of antenna groups.

10. The UE of claim 1, wherein the at least one processor is configured to cause the UE receive a configuration indicating one or more of the following antenna coherence modes: a fully-coherent mode, a non-coherent mode, or a partially coherent mode.

11. The UE of claim 1, wherein the set of parameters corresponds to Layer-1 UE features signaling associated with codebook based physical uplink shared channel (PUSCH) multiple input, multiple output (MIMO) transmission.

12. The UE of claim 1, wherein the device node is associated with a selected codebook type of a set of codebook types.

13. The UE of claim 12, wherein the set of codebook types comprises:
an antenna selection codebook type, and wherein an antenna port is selected for a precoding vector corresponding to a physical uplink shared channel (PUSCH) layer.

14. The UE of claim 12, wherein the set of codebook types comprises a codebook type that is based on a Release-15 UL codebook with a transform precoding disabled.

15. The UE of claim 14, wherein a precoding matrix corresponding to a quantity of antenna ports is an augmentation of two precoding sub-matrices, each precoding sub-matrix being based on a precoding matrix corresponding to one half of the quantity of antenna ports.

16. The UE of claim 12, wherein the set of codebook types comprises a codebook type that is based on a discrete Fourier transform (DFT)-based codebook type, wherein columns of the precoding matrix correspond to a subset of columns of a DFT matrix.

17. The UE of claim 12, wherein the selected codebook type is set by a rule based on one or more of an antenna configuration, a quantity of antenna ports, a quantity of SRS resource sets associated with the TPMI, a quantity of SRS resources associated with the TPMI, a quantity of TPMI, a quantity of antenna groups, a quantity of coherence groups, or a combination thereof.

18. A method performed by a user equipment (UE), the method comprising:
transmitting a set of parameters corresponding to an antenna configuration of the UE, wherein the antenna configuration comprises information on at an antenna grouping or a coherence grouping across antenna ports of the UE;
transmitting a set of sounding reference signals (SRSs) over the antenna ports based on the antenna configuration; and
receiving at least one transmit precoding matrix indicator (TPMI) based on the set of SRSs, the TPMI corresponding to an uplink (UL) codebook-based transmission.

19. A base station for wireless communication, comprising:
at least one memory; and
at least one processor coupled with the at least one memory and configured to cause the base station to:
receive a set of parameters corresponding to an antenna configuration of a user equipment (UE), wherein the antenna configuration comprises information on an antenna grouping or a coherence grouping across antenna ports of the UE;
receive a set of sounding reference signals (SRSs) over antenna ports of the base station, based on the antenna configuration; and
transmit at least one transmit precoding matrix indicator (TPMI) based on the set of SRSs, the TPMI corresponding to an uplink (UL) codebook-based transmission.

20. A method performed by a base station, the method comprising:
receiving a set of parameters corresponding to an antenna configuration of a user equipment (UE), wherein the antenna configuration comprises information on an antenna grouping or a coherence grouping across antenna ports of the UE;
receiving a set of sounding reference signals (SRSs) over antenna ports of the base station, based on the antenna configuration; and
transmitting at least one transmit precoding matrix indicator (TPMI) based on the set of SRSs, the TPMI corresponding to an uplink (UL) codebook-based transmission.
